(19) United States
(12) Patent Application Publication
(10) Pub. No.: US 2017/0078956 A1
(43) Pub. Date: Mar. 16, 2017

(54) COGNITIVE WIRELESS SYSTEM - PREDICTED TEMPORAL OVERLAP

(71) Applicant: Sierra Wireless, Inc., Richmond (CA)

(72) Inventor: Lawrence Joseph LeBlanc, Burnaby (CA)

(21) Appl. No.: 14/923,418

(22) Filed: Oct. 26, 2015

Related U.S. Application Data
(63) Continuation-in-part of application No. 13/944,771, filed on Jul. 17, 2013, now Pat. No. 9,173,160.
Application No. 13/944,771 is a continuation of application No. 12/289,165, filed on Oct. 22, 2008, now Pat. No. 8,516,096.
(60) Provisional application No. 61/129,638, filed on Jul. 9, 2008.

(51) Int. Cl. H04W 48/18

(52) U.S. Cl. CPC H04W 48/18; H04W 84/12

(57) ABSTRACT

A system and method is disclosed to evaluate the suitability of Wi-Fi and cellular networks by considering the temporal and spatial overlap of Wi-Fi APs

### CROSS REFERENCE TO RELATED APPLICATIONS

This application claims the priority and other benefits of U.S. application Ser. No. 13/944,771 (filed Jul. 17, 2013), all of which is herein incorporated by reference in its entirety.

### FIELD OF THE INVENTION

The present invention relates to mobile terminals operating among heterogeneous networks.

### BACKGROUND OF THE INVENTION

Wireless service providers face a network capacity shortfall due to a dramatic increase in both the number of mobile devices in use and their ability to generate and/or consume large amounts of data. The combination of these factors produces a demand that far outstrips the capacity expansion possible through evolution of any single network technology.

One way to address this capacity shortfall is through efficient and effective use of multiple, heterogeneous networks. In particular, the use of short range wireless technologies like WiFi offers significant capacity expansion through frequency reuse. With a typical 500 foot coverage radius, approximately 100 WiFi access points can be deployed in the same area as a single cell site with a 1 mile coverage radius, and each WiFi access point can deliver as much or more capacity than the entire cell site.

Unfortunately, short range, or “high density” network technologies present some significant problems for wireless service providers and their customers, including (but not limited to): (1) poor mobility characteristics due to the need for frequent and rapid switching; (2) poor propagation characteristics, particularly when using unlicensed and/or power-limited spectrum; and (3) maintenance headaches due to many more points of failure (2+ orders of magnitude).

Current attempts in multiple-network scenarios are driven from higher-level applications or processes above the datalink layer (for example, U.S. Pat. No. 7,263,252) or require much “command and control” interaction from a central network (or supra-network) managing station. Accordingly, responsiveness to local conditions or context, is reduced. The present invention addresses the responsiveness issues by centering the decision-making at the mobile terminal.

The present invention, a Cognitive Wireless System (CWS), addresses these and other issues to allow wireless service providers to make effective use of multiple networks.

### SUMMARY OF THE INVENTION

There is provided a cognitive wireless system for a mobile node (MN) to operate dynamically with heterogeneous networks, comprising: (a) a first network with characteristics, and a second network with different characteristics; (b) a first mobile node (MN) that has a policy of using said first network as a default; (c) said first mobile node (MN) having an associated first application with requirements; (d) wherein said first mobile node (MN) monitors the contextual factor of (i) link quality factor associated with said first default network and said second network; and (e) wherein said first mobile node (MN) has a link selector/algorithm that operates in real time on said monitored contextual factor of link quality of said two networks, and selects said second network to use instead of said first default network based on superior link quality factor.

### BRIEF DESCRIPTION OF THE DRAWINGS

A better understanding of the present invention can be obtained when the following detailed description of the preferred embodiment is considered in conjunction with the following drawings, in which:

FIG. 1 is a block diagram illustrating an architecture of an exemplary communications system in which a representative embodiment of the present invention may be practiced;

FIG. 2 is a schematic block diagram of a hardware architecture of one embodiment of a Mobile Node (MN) 100;

FIG. 3a is a diagram showing the layered data and control flow in the multi-network mobility management for basic mobility;

FIG. 3b is a diagram showing the layered data and control flow in the multi-network mobility management for seamless mobility;

FIG. 4 is a schematic block diagram of the Link Selector

FIG. 5 is a block diagram showing overview of dynamic multi-streaming;

FIG. 6 is a diagram showing an implementation of dynamic multi-streaming;

FIG. 7 is a diagram showing Mobile Agent Architecture (based on IEEE 802.21);

FIG. 8 shows the policy management.

FIG. 9 is a map view using the “grid square” as the Predicted Proximal Region;

FIG. 10 is a map view of the concatenation of several non-square Predicted Proximal Regions;

FIG. 11 is a map view of several candidate non-squares shapes of a Predicted Proximal Region relative to locations of APs;

FIGS. 12(a), 12(b) and 12(c) are exemplary geometric distributions for n=6, 9 within a rectangle;

FIG. 13 is published geometric distributions for packing circles in a square for n=1 to 20 (Wikipedia entry)

### DETAILED DESCRIPTION OF THE PREFERRED EMBODIMENT NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the Patent and Trademark Office file or records, but otherwise reserves all copyright rights whatsoever.

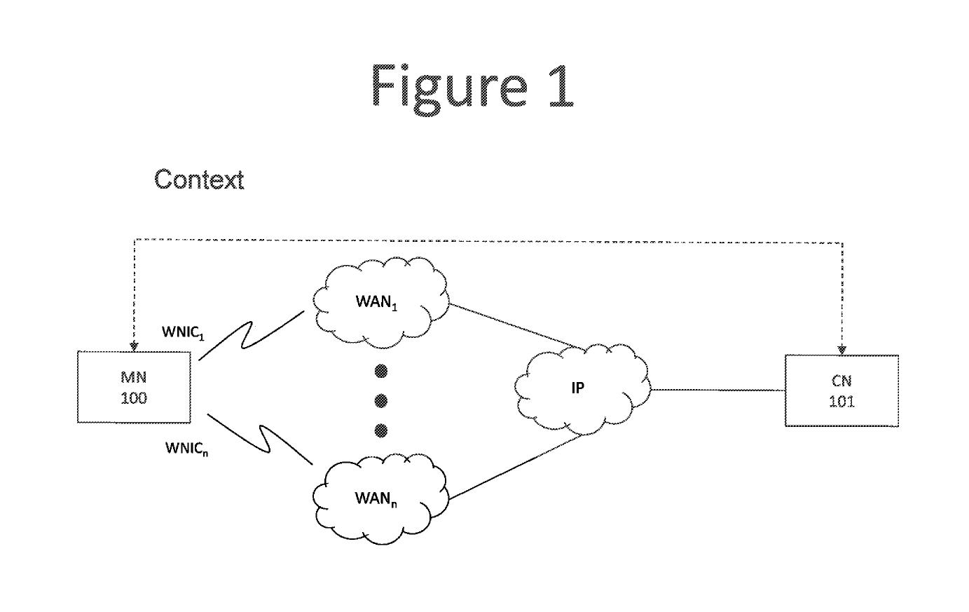

An overview is first provided in conjunction with FIGS. 1, 2 and 4, followed by a more detailed explanation organized as Dynamic Link Selector, Seamless Mobility Agent, Dynamic Multi-Streaming and Network Health.

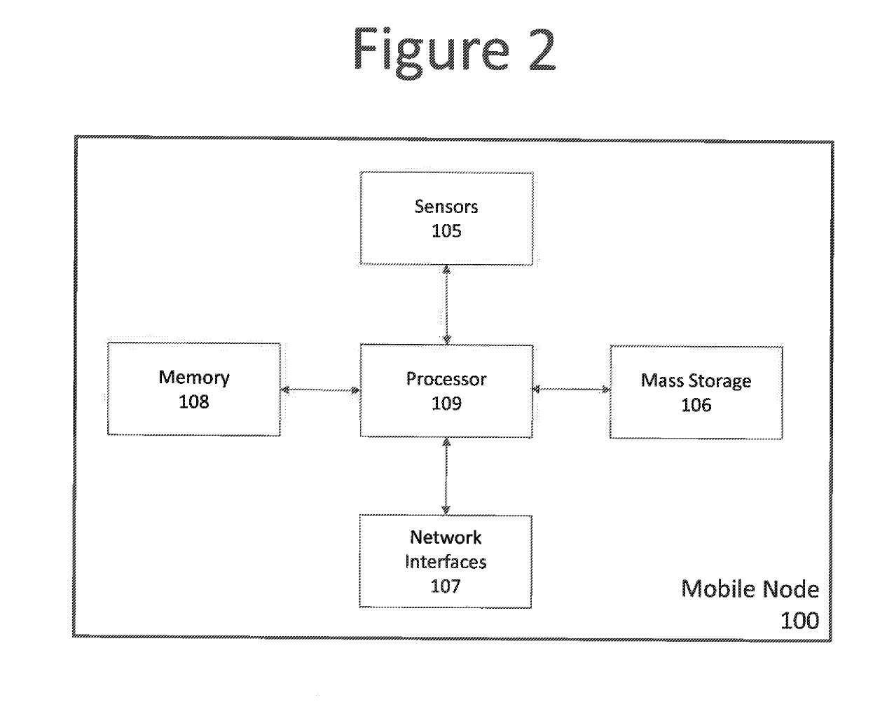

FIG. 1 shows an overview architecture of the present invention. A Mobile Node (MN) 100, equipped with a plurality of wireless network interfaces (WNICx), interacts with a Correspondent Node (CN) 101 through a plurality of wireless networks (WANx) and IP infrastructure. According to the present invention, the MN 100 selects (by itself, based on contextual factors and other conditions local to it, according to its then operating policy 205) the optimal wireless network(s) WANx over which to exchange data with the Correspondent Node (CN) 101. Herein, “policy” and “contextual factors” refer to process(es) by which a MN 100 selects link(s) at any given time, taking into account the context of the MN 100 then, and also to other aspects of its operation (e.g. usage that restricts streaming video to Wi-Fi only). Policy 205 and contextual factors, as will be explained in more detail below, are instantiated by algorithms implemented in software/hardware in interaction with local conditions. FIG. 2 shows the schematic block diagram of a hardware architecture of one embodiment of a MN 100 that is suitable for a vehicle. There is a powerful CPU 109 and associated memory 108 for inputting data from sensors 105 and selecting the appropriate link and interacting with network interfaces 107 that correspond to the WNICx. Mass storage 106 may be provided to store sensor 105 data for future reference.

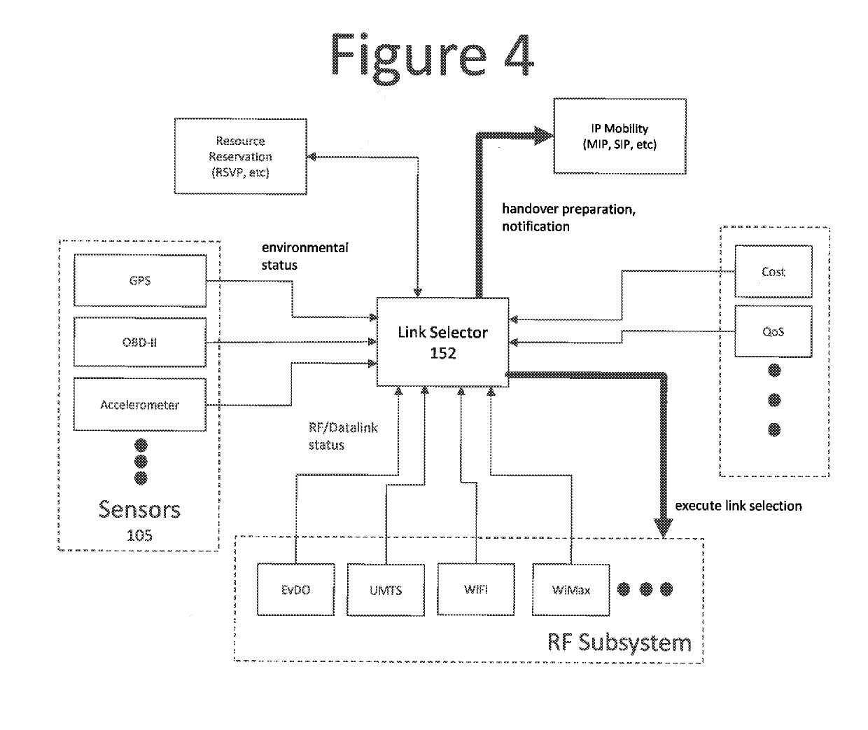

FIG. 4 shows the various inputs into the Link Selector 152. The Link Selector 152 executes (its then operating) policy 205 to select which link(s) to use for carrying traffic. It takes into account when executing policy 205

(1) local environmental conditions such as location (e.g. GPS), operating status (e.g. vehicle gear selection via OBD-II sensors at 105), and motion (eg. accelerometer); and (2) current RF conditions as well as datalink conditions (QoS) from each network interface (EvDO, UMTS, etc.). These non-limiting examples will be explained in more detail below.

Link Selector 152 may act as an admission-control module for standard resource reservation protocols (e.g. RSVP), and if the then operating policy 205 stipulates, may take application resource requests into account when selecting a link.

Link Selector 152 notifies standard IP Mobility mechanisms (such as Mobile IP and SIP) when it is about to change network attachment (handover preparation) and/or when it has completed such a change (handover notification)

The CWS Network includes: (1) a Mobility Manager (MM) 200 resident in the wireless network infrastructure (whether of the telecom provider or of the CWS Network system operator command and management structure, such as a central station); and (2) a Mobility Agent (MA) 150 resident on a mobile wireless device (MNs 100), of which there is typically a plurality.

The Mobility Manager (MM) 200 defines CWS Network system-wide policies and distributes same to the Mobility Agents (MA) 150. In addition, the Mobility Manager (MM) 200 receives network health feedback from Mobility Agents (MA) 150 and redistributes that information to affected Mobility Agents (MA) 150 through policy 205 updates and/or alerts.

The Mobility Agent (MA) 150 is responsible for selecting the appropriate wireless link(s) for its Mobile Node (MN) 100 use at any point in time, and to notify the IP Mobility layer (if one is deployed) of changes in the current network access path to enable seamless session continuity. The Mobility Agent (MA) 150 operates on policy(ies) 205 that take one or several contextual factors into account when selecting (by its Dynamic Link Selector/algorithms) a network link among a choice of links where each link has sufficient quality to qualify as a possible selection (whether that sufficiency is measured by lower level quality metrics or is influenced by higher level, application-specific metrics). The Mobility Manager (MM) 200 is responsible for maintaining the global policy(ies) 205 of the CWS Network and for distribution (and updating or modification) of policy(ies) 205 to individual Mobility Agents (MA) 150.

These contextual factors can be grouped into (informally expressed and not mutually exclusive) categories including (but not limited to) the following four, and one or more contextual factors are used as best optimizes performance for anticipated real-time scenarios.

Link Assessment. The Mobility Agent (MA) 150 takes into account network availability and signal quality (Layer 1), datalink quality (Layer 2) and IP performance characteristics such as latency and throughput (Layer 3) when selecting a link. Links that have inferior performance may be disqualified from selection even when the default or base policy 205 dictates they be used.

Environment. Environmental factors including (but not limited to) location, speed and battery power levels, provide context within which the Mobility Agent (MA) 150 can interpret policy 205 to improve network selection. For example, the default or base policy 205 may dictate that a Wi-Fi network is preferred whenever available, but the policy 205 may allow Mobility Agent (MA) 150 to ignore Wi-Fi networks when in motion because Wi-Fi networks have inferior mobility characteristics. If the Mobility Agent (MA) 150 is installed in a vehicle, it may, according to the policy 205, consult vehicle-specific parameters, such as gear selection. For example, a stationary vehicle in “Park” may be reasonably expected to remain stationary, whereas one in “Drive” may be stopped momentarily at a traffic light. In the former case, the Mobility Agent (MA) 150 may choose to use an available Wi-Fi connection, but in the latter case, it may choose to use a cellular data connection with better mobility characteristics.

Application Factors. A policy 205 may indicate use of a particular default network connection (for example, based on lower cost) that is unsuitable for a given application that must operate in real-time critical situations. The Mobility Agent (MA) 150 can evaluate the factors of an application (its requirements and its desired level of service) and modify its network selection accordingly. For example, in an ambulance emergency environment, the ECG (electrocardiogram) data maybe defined as the highest priority data and recognized as such by the policy 205, so that the Link Selector 152 will send it via the best available network interface in precedence over (and perhaps regardless of other contextual factors like cost). Other application data may be less time sensitive and so is given weight by the policy 205 as desirable but not determinative of the link selection.

Cost is another contextual factor. Operating among heterogeneous networks, some networks have their own telecom service providers (e.g. cellular system provider) and associated costs. These costs may be fixed by published tariffs or may be dynamic (based on real time factors, like time of use). For consumer or other end users and applications that are cost-sensitive, the CWS Network system operator may set (and later update or modify) a policy 205 that gives much weight to minimizing cost (or keeping costs to a contractually promised level) and consequently, would select links with less performance but were cheaper.

The contextual factors can be employed in different combinations and with different weights, as the CWS Network system operator architects for his desired scenario outcomes. Consider the two preceding and opposed examples above, where link performance factor trumps cost factor and vice versa.

Dynamic Link Selector

A popular method for selecting between multiple connection options involves assigning a preference score (typically linked to cost or performance, as detailed below in examples) for each link and then selecting the highest scoring link relative to a base or default preference link (assigned by the CWS Network system operator). In a mobile/wireless environment a static link preference is often suboptimal because the best link tends to change depending on a wide array of contextual factors including (but not limited to): location, speed, time-of-day, link QoS, application requirements and application preferences (e.g. security, transmission bandwidth, cost). A mechanism for specifying a dynamic preference score for each link option is required for optimal results.

There is provided: a mechanism for defining a base preference for a communication link; and a mechanism for using a link other than the base preference, based on arbitrary, variable attributes such that when a policy 205 is executed with current value(s) of the contextual factor(s), it generates a preference score adjustment (.+−.) for each link option.

A Dynamic Link Selector 152 resides in the Mobile Node (MN) 100 that selects the link to be used in real time by executing one or more policies that take into account, contextual factors (some whose values vary in real time, some whose values are assigned arbitrarily by the CWS Network system operator) and applying the resulting policy 205 “scores” relative to the base preference link, i.e. to use another link or not, and when to return to the base preference link. Below are examples of the dynamic selection of links, the first based on recent historical “up time” and the second based on the speed-sensitivity of the Mobile Node (MN) 100.

For example, a policy 205 generates a preference score adjustment of −3 for each link upon notification of a link failure event, and a preference score adjustment of +1 for each minute of connection uptime up to a maximum equal to the base preference link. In this case, if the Wi-Fi link fails, its preference score would drop from 10 to 7 and the EvDO link would become active. One minute after the Wi-Fi link recovered, its preference score would be updated to 8, equal to the EvDO link. Traffic would not yet switch. If the Wi-Fi link failed at this point, its preference score would drop to 5. Four minutes after recovery, the Wi-Fi link would achieve a preference score of 9, and traffic would once again switch back to Wi-Fi.

For the second example, consider that high-density networks such as municipal Wi-Fi deployments provide higher throughput and overall capacity than conventional macro-cellular systems due to their high degree of spectrum re-use. However such networks have problems dealing with mobile users, particularly ones traveling in vehicles, due to rapid switching requirements. A Wi-Fi AP under optimal conditions can sustain performance over a range of about 305 meters (or 1000 feet) at best. If a vehicle travels at about 48 km/hour (or 30 mph), it covers about 305 meters (or about 1000 ft) every 22 seconds; at 96 km/hour (or about 60 mph) the window shrinks to 11 seconds. This puts a burden both on the client—to scan at a high enough rate to detect new APs and reliably predict which of several available APs to switch to before losing the existing AP connection—and on the network—to update bridging/routing rules to track the client as it moves from AP to AP.

Ideally, a Mobile Node (MN) 100 will take advantage of the high-density network when stopped or moving at a reasonable speed and switch to an alternate network with better mobility characteristics when it begins moving.

Accordingly, there is provided: a Mobile Node (MN) 100 equipped with multiple wireless Interfaces; and a mechanism for specifying preference for one interface over another; mechanism for specifying the relationship between speed and the aforementioned preference; and a mechanism for measuring the speed at which the Mobile Node (MN) 100 is moving (e.g. GPS, OBD-II)

Optionally, there is provided a mechanism to infer the intent of the user of the MN 100 about continuing to move or to continue to rest (e.g. gear selection, braking status, location).

For example, MN 100 is equipped with two wireless interfaces—an IEEE 802.11g Wi-Fi interface and an EvDO interface. The device also has embedded GPS capabilities to determine speed. The 802.11g interface is configured with a default preference score of 100 while the EvDO interface is configured with a default score of 90. Furthermore, the 802.11g interface is configured with a preference penalty of −1.25 km/hour (or about −2/mph). So at 8+ km/hour (or about 5+ mph) the EvDO link becomes the preferred network and the Mobile Node (MN) 100 switches traffic to that interface. When the Mobile Node (MN) 100 slows to <=5 mph, the Mobile Node (MN) 100 switches back to Wi-Fi (if available).

The examples above are simple non-limiting ones that show a granular implementation of the policy 205 aspects of the Link Selector 152. The CWS Network system operator may develop a policy or policies 205 that take into account many contextual factors and relate them—by Boolean algebra, by fuzzy logic, non-linearly, by applying different weights to each—as can best optimize performance for the anticipated subject field scenarios.

Seamless Mobility Agent

The Mobility Manager (MM) 200 can provide or host several services. First, it can host the Seamless Mobility Agent (SMA) 151, which in turn may be part of the Dynamic Multi-streaming, and the Network Health service, all explained below. Secondly, it may provide QoS feedback for the MN/MA Link Selector 152. Thirdly, it hosts CWS Network management functions that support the aforementioned services (e.g. a reporting engine to provide real-time and historical correlation of network events with geographic location, speed, and other environmental factors to help improve the accuracy and efficiency of Link Selector 152 algorithms; verification of service level agreements between the telecom wireless network provider(s) and the user(s)).

Note that some or all of the Mobility Manager (MM) 200 services described can be hosted by a telecom provider or by the CWS Network system operator's central station.

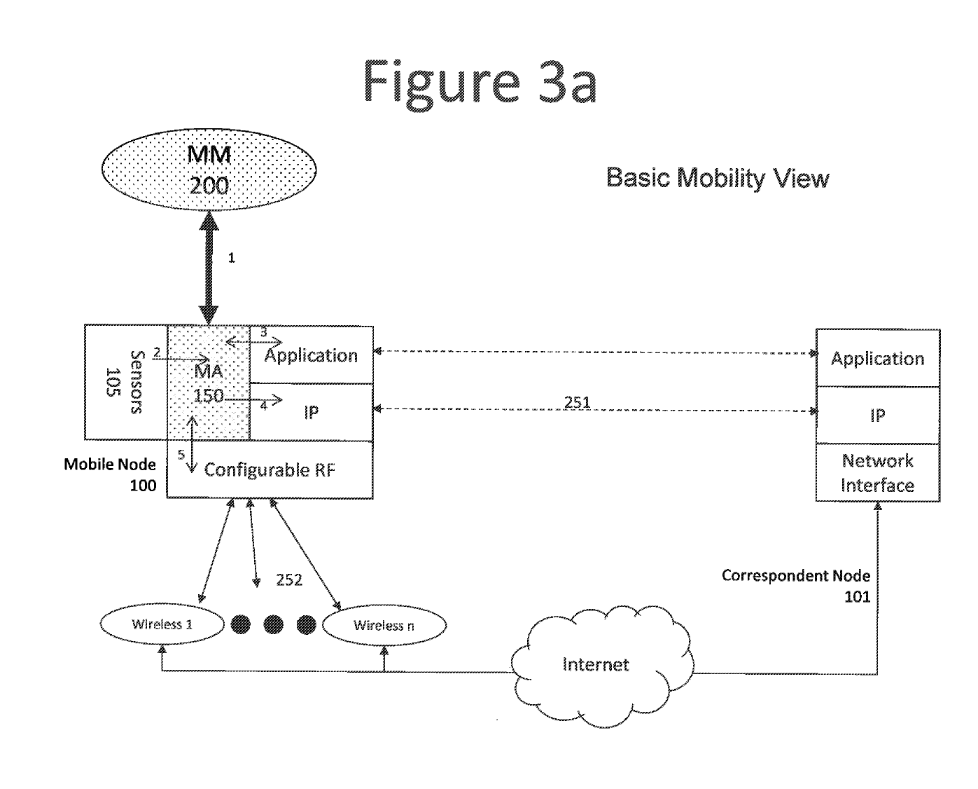

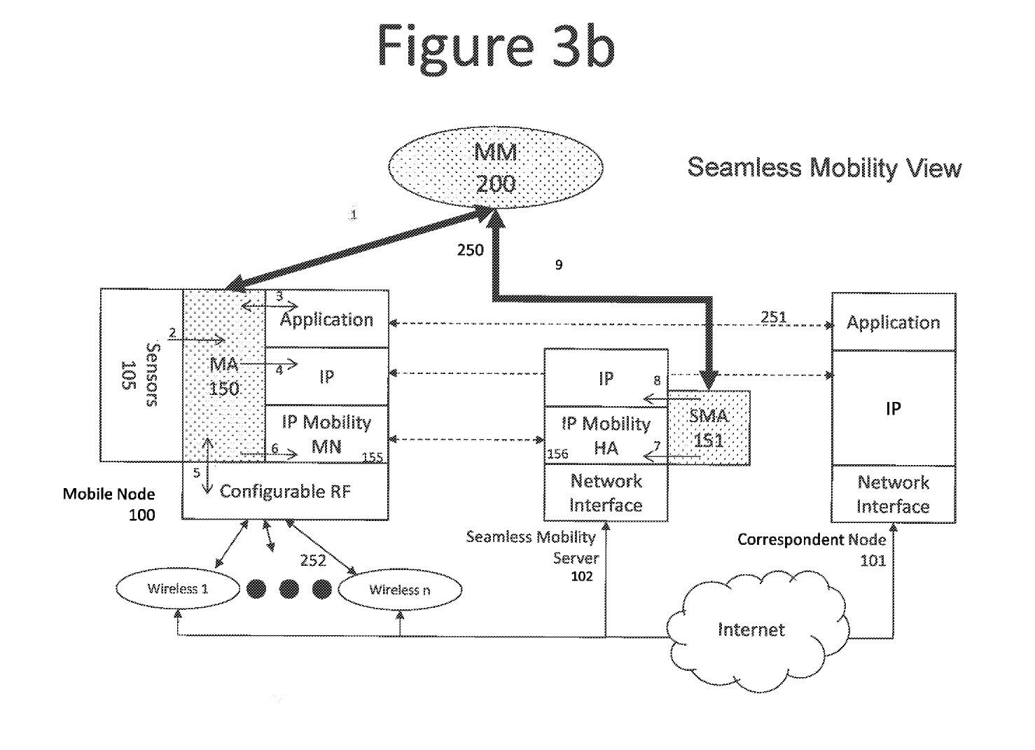

With reference to FIGS. 3a and 3b, the Seamless Mobile Agent (SMA) 151 provides several services. First, it acts as a virtual network interface (VNIC) which acts as a proxy for the Mobile Node (MN) 100, in effect hiding the various WANx over which the MN 100 is communicating with the Correspondent Node (CN) 101. In particular, it and the MN 100 cooperate to provide multi-streaming (i.e. distribute traffic from an MN 100 redundantly over multiple WANx and have it consolidated by the Seamless Mobile Agent (SMA) 151 into a single stream) to enhance reliability of communications and minimize or eliminate switching time to provide true seamlessness.

Interface 1: MM 200MA 150. This is the control plane interface used for distribution of policy 205 (MM 200.fwdarw.MA 150) and collection of network health information (MA 150.fwdarw.MM 200), with more details explained below in connection with network health.

FIG. 3a shows the data and control flow of the deployment scenario for applications that are tolerant of IP address changes, connection dropouts and the like (for examples, basic web surfing, email, etc.).

Interface 1: MM 200MA 150. This is the control plane interface used for distribution of policy (MM 200.fwdarw.MA 150) and collection of network health information (MA 150.fwdarw.MM 200), with more details explained below in connection with network health.

Interface 2: Sensors 105.fwdarw.MA 150. The sensors 105 provide environmental inputs (location, speed, gear selection via OBD-II, and the like related to a vehicle which transports the MN 100) for use in link selection (i.e. contextual factors for the Link Selector 152).

Interface 3: MA 150 Application. Optional interface used to allow applications to request link QoS parameters and for the MA 150 to advise applications of current connectivity state.

Interface 4: MA 150.fwdarw.IP. The MA 150 manipulates routing, firewall, and other IP-layer parameters based on current link selection and usage (eg. streaming video only allowed on Wi-Fi, etc).

Interface 5: MA 150 Configurable RF. The MA 150 receives RF status information (for examples, availability, QoS) and executes changes to the RF layer as required. Configurable RF could be SDR or selectable hardware implemented RF boards or a combination of both.

FIG. 3b shows the data and control flow in the deployment scenario for applications that are not tolerant of IP address changes and/or connection dropouts (e.g. VoIP, streaming audio/video, etc).

Seamless Mobility Server (SMS) 102 is introduced to provide an anchor point in the network to hide the existence/use of multiple wireless network interfaces from the Correspondent Node (CN) 101.

SMS 102 hosts an IP Mobility Home Agent (or HA 156), and the Seamless Mobility Agent (SMA 151).

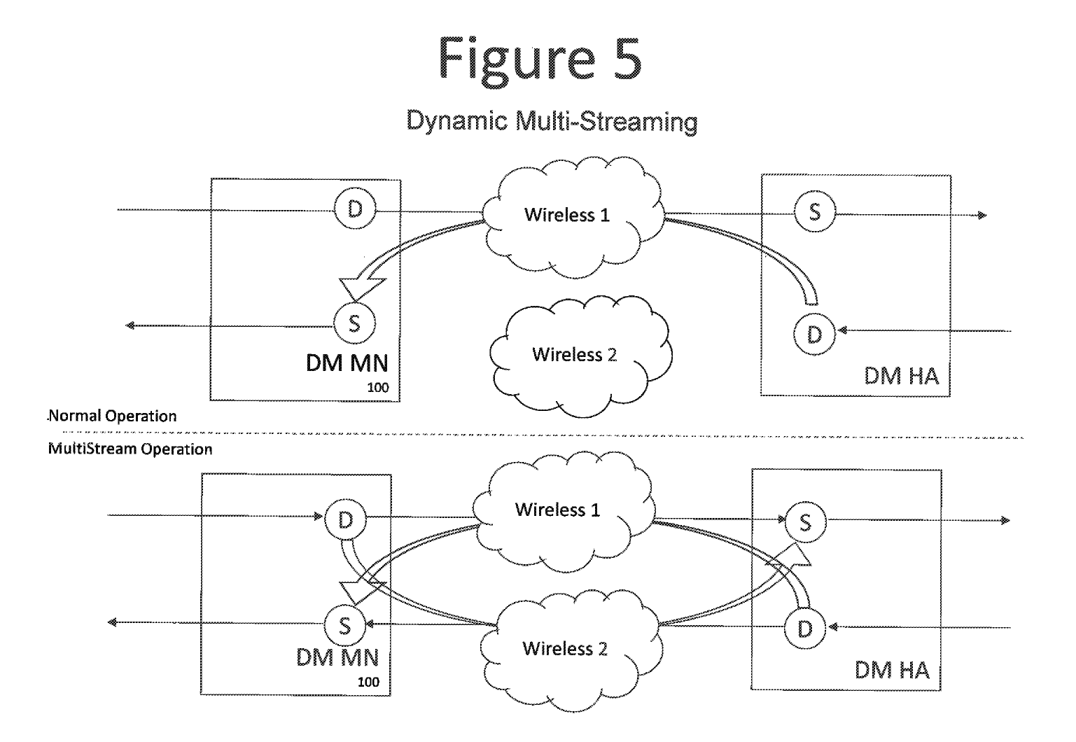

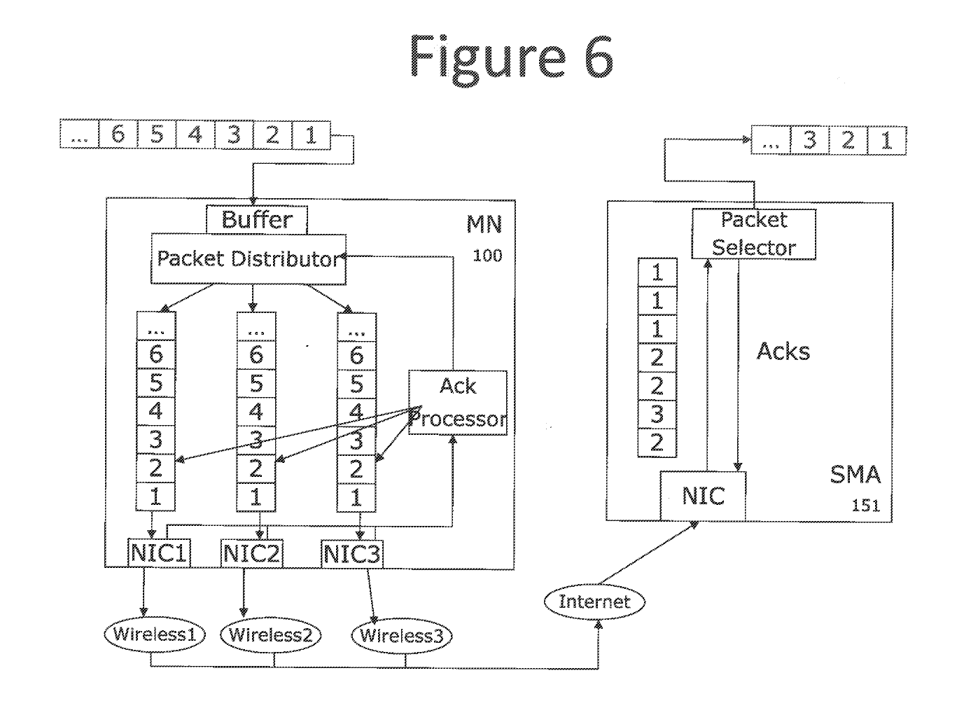

IP Mobility may be provided by standard components (Mobile IP, MOBIKE, etc) or by the Dynamic Multi-Streaming Protocol (see FIGS. 5 and 6 and explanation below).

Interfaces 1-5 are the same as in FIG. 3a.

Interface 6: MA 150.fwdarw.IP Mobility MN 155. The MA 150 notifies IP Mobility layer of pending or completed vertical handoff.

Interface 7: SMA 151.fwdarw.IP Mobility HA 156. The SMA 151 modifies behavior of IP Mobility HA 156 based on policy 205 and Network Health information provided by the MM 200.

Interface 8: SMA 151.fwdarw.IP. This is the same function as interface 4; SMA 151 adjusts routing, firewall and other Layer 3 parameters based on current link selection and usage policy 205 dictated by MM 200.

Interface 9: MM 200 SMA 151. Similar to interface 1 in being a control plane interface; MM 200 distributes policy 205 to SMA 151 and collects CWS Network health/utilization information from SMA 151.

In FIGS. 3a and 3b, thick arrows 250 represent CWS Network system control signal channels, dashed arrows 251 represent (Internet model) layer correspondence, and thin arrows 252 represent data traffic and associated protocol-dependent control signals.

Dynamic Multi-Streaming

There are a variety of IP Mobility mechanisms available including Mobile IP (v4/v6), HIP, UMA, etc. In addition there are application-layer session management systems (including SIP, for example). Also, there are attempts at fast-handoff mechanisms to allow for switching between networks. Many of these mechanisms work well when the MN 100 (and/or the network) has the opportunity to “choose” to switch. An example is the UMA scenario of handing off a voice call from a cellular network to a home Wi-Fi network and back. The transition works well from cellular to Wi-Fi because the MN 100 can maintain the cellular connection while preparing for the handover to Wi-Fi. However the reverse transition does not work well because it is difficult to predict accurately when the Wi-Fi connection is going to break.

The standard practice for this scenario is to introduce buffering both at the Mobile Node (MN) 100 and its Home Agent (HA) 156 in the network, allowing traffic flow to be suspended while the network switch is made. Although functional, this approach poses problems for real-time data applications like VoIP and streaming video

An alternative to this approach is to redundantly stream packets over multiple networks when available, using a selector mechanism at the far end to take the first copy of a packet to arrive and discard the rest. This removes the need for buffering and/or accurate link failure prediction by ensuring any given packet is “in flight” via multiple paths to minimize/eliminate the impact of a failure of any one path. The downside of such an approach is the substantial expense in power consumption and network capacity utilization.

The present invention extends the concept of “simultaneous binding” found in Mobile IP, which allows a MN 100 to register multiple care-of addresses (CoAs) with its Home Agent (HA) 156 to facilitate rapid switching between them. In Mobile IP with simultaneous binding, one CoA is designated “current” and used for all communications until such time as the MN 100 instructs the Home Agent to begin using an alternate CoA. One can redundantly stream by registering and using all CoAs.

The present invention involves the creation of new service primitives that allow the Home Agent to initiate or terminate simultaneous redundant streaming of data packets over two or more of the available CoAs (i.e. multi-streaming). For example, according to Network Health service (explained below), in order to warn relevant MNs 100 to avoid a particular link, the MM 200 may send alerts or policy 205 updates through simultaneous redundant streaming of data packets over two or more (or all, depending on urgency) of the available CoAs. Similarly, going the other way, a MN 100, upon detecting degraded performance over its preferred link, is equipped to do likewise by initiating simultaneous redundant streaming to MM 200. If the preferred link regains acceptable QoS levels, the MN 100 invokes another service primitive to terminate the multi-streaming. If the selected network continues to degrade and fail, the data traffic is uninterrupted because it is already running on an alternate path(s).

For example, it is more efficient in most cases for a mobile device/MN 100 equipped with both 3G and Wi-Fi network interfaces to use Wi-Fi when available. Systems such as UMA and FMC have been developed to facilitate the handoff of sessions from one network to another in such devices. However performance of such systems is limited by the fact that Wi-Fi links tend to break abruptly, allowing little or no time to prepare for a handoff to a backup network. A common manifestation of this problem is that sessions can be handed off successfully from 3G to Wi-Fi but not in the reverse direction. With dynamic multi-streaming, the MN 100 can take factors other than simple signal availability and/or quality into account. If GPS or accelerometer information is available, a Mobile Node (MN) 100 that is currently using a Wi-Fi connection can begin multi-streaming over cellular as soon as it detects that the device is in motion. If the device comes to rest again without losing the Wi-Fi connection the multi-streaming can be turned off, but if it keeps moving eventually the Wi-Fi link will break and the session will be maintained seamlessly (zero packet loss) via cellular.

As shown in FIG. 5, each Dynamic Multi-streaming Node has a Packet Selector S and Packet Distributor D. Data being transmitted by the node passes through the Packet Distributor D which decides over which link(s) to send the data. In steady-state Normal Operation, the data is transmitted over only one network interface for efficiency. But if conditions arise (e.g. motion, degraded QoS, etc) that indicate the primary connection is in jeopardy, the Packet Distributor D will begin MultiStream Operation, i.e. redundantly transmitting the data on one or more additional links as necessary, available or instructed. The Packet Distributor D tags each data packet with an identifier so the Packet Selector S on the receive side can select one packet and discard extra copies of packets if they arrive.

The trigger to initiate multi-streaming need not be QoS related; it may be something in the environment that suggests the preferred link has a greater than prescribed risk of failure. For example, Wi-Fi networks tend to break abruptly when the Mobile Node (MN) 100 is in motion, so if the Mobile Node (MN) 100 is able to detect that it is moving then it may start multi-streaming on cellular even though the Wi-Fi link has shown no significant degradation.

FIG. 6 shows a possible implementation of the dynamic multi-streaming approach that is not dependent on Mobile IP. For simplicity of illustration, only one direction of data flow (MN 100 to Home Agent (HA) 156) is shown; and no control channel flow, whereby the Mobile Node (MN) 100 coordinates the initiation or termination of multi-streaming, is shown. The “virtual NIC” resides on the Mobile Node (MN) 100. Traffic is buffered and distributed across one or more physical NICs based on policy 205, e.g. preferred NIC only under normal conditions, multiple NICs when preferred network shows signs of degradation. A Packet Selector S on the far end (the IP Mobility Home Agent (HA) 156 or more generally, the Seamless Mobility Agent (SMA) 151) acknowledges each packet upon reception of the first copy; when the virtual NIC receives the acknowledgment, it purges any copies of the packet that may still be in the queue for transmission on slower or redundant links. The uses of redundant multi-streaming explained above with Mobile IP and CoAs, are equally applicable to this alternative implementation.

The Seamless Mobility Agent (SMA) 151 also has real time knowledge of the operation of each WANx and so can provide the MN 100 with real-time QoS information on each WANx as one contextual factor in selecting a link.

Network Health

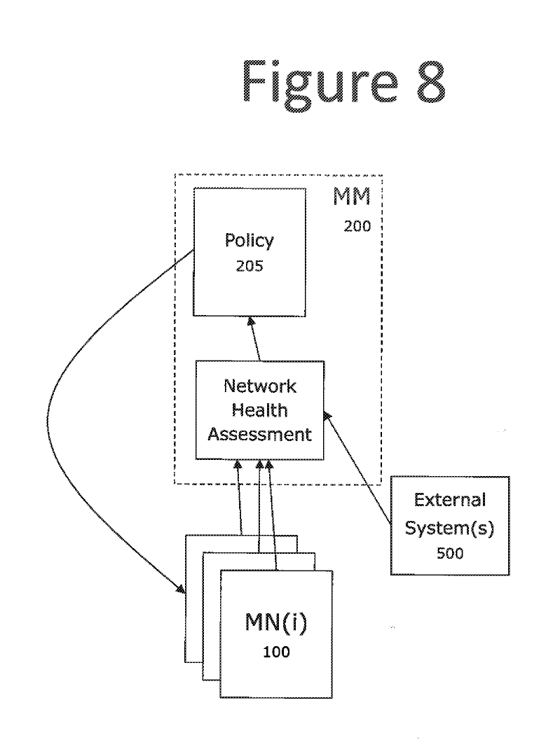

The health of a wireless network is a complex, dynamic combination of a plurality of factors—for examples, the RF environment, status of the RF components, connectivity from the network access point to the destination Inter/intranet, AAA services, etc. Many faults in this complex environment are difficult to detect from any location other than locally by the client that is suffering the faulty service, i.e. physically proximate to the place of fault. Moreover, it is often difficult for Mobile Node (MN) 100 to determine there is a problem until it attempts to connect and pass traffic over the damaged infrastructure—e.g. RF signals may be of good quality, authentication may succeed, but Layer 3 traffic may be blocked or degraded due to downstream network issues. Once an MN 100 has encountered a problem, it would be beneficial for that information to be shared with the, for example, wireless service provider so it can initiate repairs, and also with other MNs 100 so they can avoid the same problem by using alternate networks and/or points of attachment (PoAs) at their disposal. The key is real-time client-side information from the MNs 100. FIG. 8 shows the policy 205 management. MN 100 obtains policy 205 updates from MM 200 both through query and “push” notifications, e.g. for network health-driven policy 205 updates and alerts. Mobility Manager (MM) 200 receives network health reports from Mobile Nodes (MNs) 100 and possibly other inputs from external systems 500 (e.g. network infrastructure monitoring systems) and adjusts policy 205 accordingly through Network Health Assessment 210.

The Mobility Agent (MA) 150 monitors the status of wireless connections via one or more wireless network interfaces WNICx on a Mobile Node (MN) 100. It detects problems at various levels and reports them to the MM 200. The MM 200 evaluates the report (possibly in conjunction with reports from other MNs 100), diagnoses the global situation, and distributes a warning alert to other MNs 100 that may be affected by the same problem(s), to assist them in making better link selection and handover decisions. The Mobility Manager (MM) 200 may also initiate trouble-tickets to expedite resolution of the detected problem(s). Upon closure of the trouble-ticket, the MM 200 can revoke the problem notification so MNs 100 once again use the associated network infrastructure. Examples of problems detected include: (1) failure to detect signal from a PoA that should be available; (2) failure to associate with an authorized PoA; (3) failure to pass IP traffic after successful association with PoA; and (4) degraded service from PoA and/or parent access network.

For example, a MN 100 enters a vicinity within which Wi-Fi service is expected to be available. The MN 100 activates its Wi-Fi NIC, locates the intended SSID/BSSID and associates successfully, but finds it cannot establish a TCP connection. The MN 100 reconnects to its alternate HSPA connection and notifies the MM 200 of the service outage. The MM 200 correlates this report with other evidence (e.g. reports from other MNs) identifying that BSSID as the source of the problem. The MM 200 then distributes a message to all MNs 100 in or approaching the vicinity advising them to avoid switching to this particular BSSID and simultaneously issues a trouble ticket. While the trouble-ticket is open, the MM 200 continues to advise approaching MNs 100 of the problem. When the trouble-ticket is closed, the MM 200 notifies all MNs 100 in the vicinity that the BSSID is once again available for service.

For another example, MM 200 broadcasts to all non-critical MNs 100 (e.g. mobile devices/equipment that are not critical to public safety) in a particular geographic area to stay clear of spectrum required by public safety personnel responding to an emergency, reserves (or causes the telecom service provider to reserve) particular spectrum, and informs the relevant public safety equipment entering that area, of the spectrum that has been reserved for them.

For other examples, the CWS system operator modifies the policy 205 for a certain class of MNs 100 and their then policy 205 default network, in favor of another default network link, or modifies the weight given to certain contextual factors like cost and QoS.

Overview

From the above, the following overview of the CWS is seen.

The MA 150 is deployed on the mobile device as part of the MN 100 and implements standard IP mobile functionality, and is responsible for: presenting a standard virtual network interface to the IP layer; collecting sensor 105 input and feedback from the RF system; exchanging policy 205 and operational status information with the MM 200; configuring radio(s) in the RF layers selecting the radio link dynamically based on contextual factors; negotiating a secure data path over the selected network link with the Seamless Mobility Agent (SMA) 151; dynamically adjusting the preceding as conditions change; and providing APIs for applications.

The MA 150 can also negotiate a data path with other MAs to form ad-hoc peer-to-peer networks when necessary or desirable/efficient (e.g. central infrastructure has failed or is not available; communication between two co-located mobile devices, sharing of limited back-haul resources, e.g. satellite uplink).

The Seamless Mobility Agent (SMA) 151 is deployed in the service provider's access network or at the customer data center for those who need to roam across multiple service provider networks. The Seamless Mobility Agent (SMA) 151 is responsible for terminating the secure data path from one or more MAs 150. The Seamless Mobility Agent (SMA) 151 implements standard IP Mobility functionality, and has at least the corresponding functionality to interact with the MAs 150 and their functionality (as described above) and also has additional functionality (e.g. multi-streaming and Network Health functionality).

Thus it is seen that working together, the Mobile Agent (MA) 150 and Seamless Mobility Agent (SMA) 151 create a “Layer 2.5”, managing multiple Layer 2 links to provide a seamless Layer 3 (IP) operation.

Communication between the Mobile Agent (MA) 150 and Mobility Manager (MM) 200 occurs primarily through messaging at the IP layer. Traffic prioritization schemes such as DiffServ may be used to ensure delivery of high-priority messages ahead of user traffic. In some cases lower-level messaging may be used in cases where it is inefficient or impossible to deliver messages via IP, for example when sending out notifications of large scale network outages or public-safety diversions (clearing portions of the network for public safety use). In these situations layer 2 mechanisms such as the 802.21 Link SAP may be used to exchange information between the Mobility Manager (MM) 200 and Mobile Agent (MA) 150 even if no IP layer connection to the network(s) exists.

Mobile Node (MN) 100 and Mobile Agent (MA) 150 may be implemented by any computerized system with communication means by which to conduct wired and wireless communications with other entities or parties. In various embodiments, MN 100 may take the form of computer system or a mobile wireless device configured to perform the methods and processes discussed herein. For example, MN 100 may be a cellular phone, personal digital assistant (PDA), portable computer, handheld device or the device described above in connection with FIG. 2. The MN 100 may be found on an emergency vehicle (e.g. police cruiser, ambulance) that is interacting, or interactable with, heterogeneous networks and systems both within the vehicle and without. The range of heterogeneity of networks, interfaces and protocols is not limited and includes common circuit-switched/packet switched networks, WLANs, LANs, Bluetooth, TDMD/CDMA, 2G, 3G, GPRS, Infra-red.

A Mobile Node (MN) 100 may be implemented on a variety of hardware platforms. One possible implementation is to combine a Pentium-class x86 (processor 109) with 256 MB of memory 108 and 1 GB of mass storage 106 implemented using flash memory, and four wireless network interfaces 107 (e.g. Wi-Fi, WiMax, UMTS-HSPA, LTE, EvDO Rev A). Sensor 105 inputs may include GPS, accelerometers, or vehicle computer inputs (engine status, gear selector, etc). Link Selector 152 software may be implemented in a high level language such as Java, C or C++, or (wholly or partially) as firmware.

The Mobility Manager (MM) 200 may be implemented in a high level language such as Java, C or C++ using a conventional SQL database (Oracle, MySQL, etc) for storage of configuration and state information as well as event history. The Mobility Manager 200 may be deployed on general purpose hardware. CPU, memory, mass storage and network connection capacity must be allocated based on the number of mobile nodes that the mobility manager is intended to support.

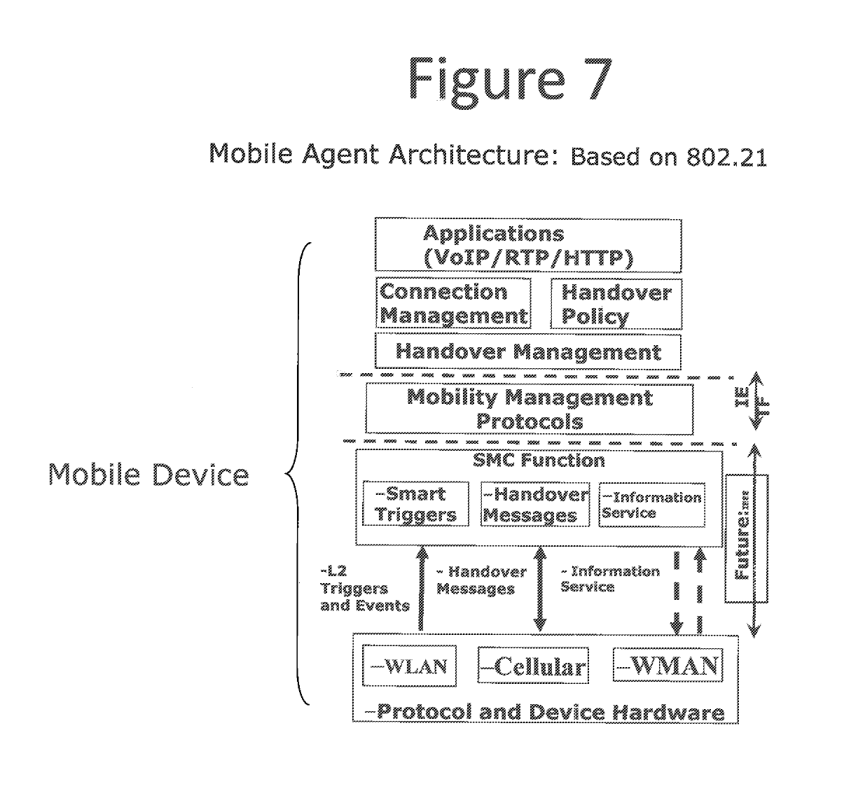

FIG. 7 shows a Mobile Agent (MA) 150 architecture based on IEEE 802.21 for standards to enable handover and interoperability between heterogeneous network types including both IEEE 802 and non-802 networks.

Certain words and phrases used throughout this patent document: the terms “include” and “comprise” and derivatives thereof mean inclusion without limitation; the term “or” is inclusive, meaning and/or; the phrases “associated with” and “associated therewith” and derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “manager” means any device, system or part thereof that controls at least one operation, and such a device may be implemented in hardware, firmware or software, or some combination of at least two of the same. It should be noted that the functionality associated with any particular manager may be centralized or distributed, whether locally or remotely.

Definitions for certain words and phrases are provided throughout this patent document, those of ordinary skill in the art should understand that in many, if not most instances, such definitions apply to prior, as well as future uses of such defined words and phrases. Following are short definitions of the usual meanings of some of the technical terms and abbreviations which are used in the present application. (However, those of ordinary skill will recognize whether the context requires a different meaning.) Additional definitions can be found in the standard technical dictionaries and journals.

WLAN—wireless local area network; a local area network that transmits over the air typically in an unlicensed frequency such as the 2.4 GHz band. Typical WLAN protocols comply with IEEE 802.11 standards.

Bluetooth—A Wireless personal area network (PAN) standard for short-range applications; uses 2.4 GHz band at 720 kbps within 30-foot range. “Bluetooth” is a trademark owned by Telefonaktielbolaget L M Ericsson.

AAA—authentication, authorization and accounting, is the protocols to provides these services.

AP—Access Point within Wi-Fi network.

GPS—Global Positioning System is the Global Navigation Satellite System that was developed by the United States Department of Defense.

HIP—Host Identity Protocol.

HSPA—High Speed Packet Access (HSPA) is a collection of mobile telephony protocols that extend and improve the performance of existing UMTS protocols.

MOBIKE is a Mobile and Multi-homing Protocol established by RFC 4555 IKEv2.

Mobile IP—an Internet Engineering Task Force (IETF) standard communications protocol that is designed to allow mobile device users to move from one network to another while maintaining a permanent IP address.

NIC—Network Interface Card, is computer hardware designed to allow computers to communicate over a computer network.

OBD II and variations (e.g. EOBD)—On Board Diagnostics II technology and protocols (which themselves rely on SAE and ISO standards) that refer to a vehicle's self-diagnostic and reporting capability.

PoA—Point of Attachment—is the first point in the network that acts as the MN 100 counterpart for a specific type of communication relationship (e.g., L2, L3, Media Independent Handoff).

QoS—Quality of Service, is the ability to provide different priority to different applications, users, or data flows, or to guarantee a certain level of performance to a data flow within a communication network.

RSVP—Resource Reservation Protocol, is an IETF standard communications protocol that allows end devices to request Quality of Service (QOS) “guarantees” from the communication network.

SIP—Session Initiated Protocol—is an IETF standard communications protocol that is designed for creating, modifying, and terminating sessions with one or more participants.

SSID/BSSID—Service Set Identifier/Basic Service Set Identifier, is a name used to identify the particular WLAN to which a user wants to attach.

SDR—Software Defined Radio

UMA—Unlicensed Mobile Access, is the commercial name of the 3GPP Generic Access Network, or GAN standard.

A communications network has characteristics, including (without limitation) those related to mobility, propagation, cost, latency, data throughput, bursty/regular, security, communications protocol(s). Herein, “heterogeneous networks” are those networks having different characteristics, that a mobile device or mobile node must use as it travels.

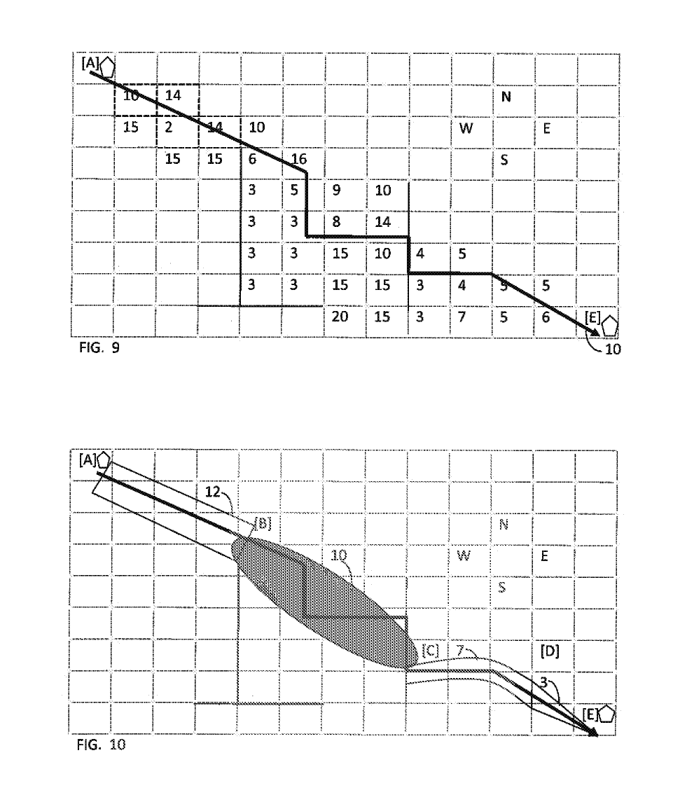

The illustrations of FIGS. 9-12, despite some apparent similarities to each other and to possible artifacts on the ground, are not rendered to scale (whether to each other and otherwise) and are represented and presented only to assist the understanding of the inventive principles.

Examples and descriptions described as exemplary, are provided herein are provided as non-limiting and merely as illustrative examples of the inventive principles of which they are only one instantiation (and are often simplified for ease of illustration and explanation). Similarly, the term “includes” is meant in a non-limiting way, so that the term “includes” is to be interpreted as “includes but not limited to”.

Contextual Factors

As explained above, the selection of networks in a heterogeneous network situation, involves calculations involving Contextual Factors about a mobile node.

Contextual Factors can be grouped into (informally expressed and not mutually exclusive) categories including (but not limited to) the following four—environment (at or proximate the mobile node), (communications) link assessment, cost (of using the networks) and application (requirements).

Vehicular Mobile Node

Hereinafter, the term, “vehicular mobile node” refers to a mobile node (whether a discrete device, like a laptop or smart phone carried by a traveler, or part of the vehicle's communications infrastructure) that is carried in a vehicle travelling on a road system and is provisioned with conventional GPS and GPS-based technologies (to obtain the location, velocity, acceleration and related mobility-derived information about the node). Herein, such information about the (vehicular) mobile node and those of the vehicle are considered to be the same, and are known (or calculatable or learnable) by the (vehicular) mobile node.

Road and Route

Herein, a “road” refers to the physical road of the road system on which a vehicle (and hence, vehicular mobile node) travels. Herein, a “route”, as initially established (by (vehicular) mobile node (user) and/or Mobility Manager 200), is a determined path on the roads of the road system on which a vehicle travels. A route begins with a start location on a road and terminates with an end location on a road. Herein, for economy of expression, a reference to “route” without explicit reference to a road, includes a reference to the road that the vehicle travels on where the context permits such interpretation. Examples of terminal route locations include the driver's home, a bus system depot lot, a hospital, sports venue, shopping mall and an emergency scene.

Without a route being established initially (or if vehicular mobile node travels on an established route but then deviates therefrom), the path for the vehicle/vehicular mobile node, is predicted based on more local information and so the methods explained below that rely on the information provided by a route, will not be applicable but some methods will remain applicable (as elaborated below).

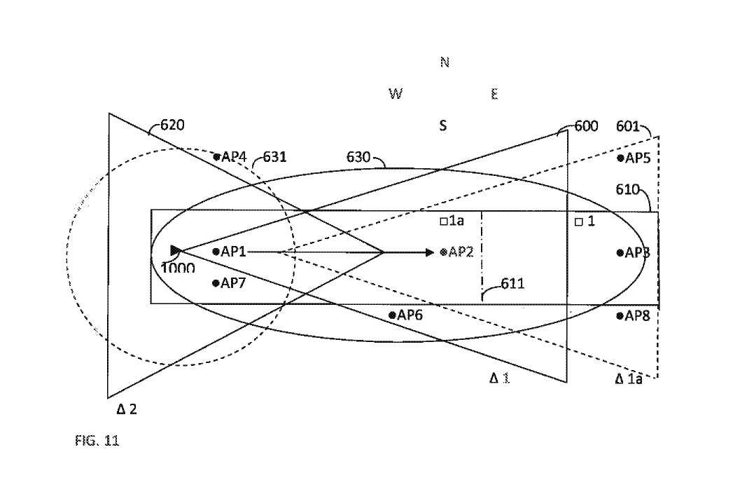

Examples of routes include a published public transport bus route, a private tour bus route, a route generated by generally available navigation hardware/software (e.g. GPS-based systems, “Google Maps”), or a route determined by proprietary software (such as one that optimizes the pick-up and/or drop-off path for a private courier delivery company). The motivation and details of a route (and how it is “covered” by Predicted Proximal Region(s), elaborated below) may be a prediction (for example, based on the history of travels of the vehicle and/or mobile node) but once a route is established, a route generally allows no deviation of travel (e.g. on a public transit bus route) but is flexible enough to contemplate some minimal deviation in some situations (e.g. for a tourist bus route, some deviation is allowable as long as certain sites of tourist interest are timely visited). A personal example of a route based on a prediction is a (vehicular) mobile node/user who historically goes to certain addresses on certain dates/tines by the same route (which corresponds to, in the real world, a son performing filial piety by visiting his mother's nursing home every Sunday afternoon and then going to his favored golf course). An illustrative route [A→E] is shown in a dark, bold arrowed line segment in FIGS. 9 and 10.

A route provides useful information about the future and is used to predict the future movement of a vehicle at any given time, and thus helps in the calculations (including those for PTO (Predicted Temporal Overlap—measured in time units), PPR (Predicted Proximal Region—delineated by geographical coordinates), Predicted AP Proximities—measured in distance units), and other concepts and metrics, as elaborated below) to decide if and when to switch between a Wi-Fi network and a cellular network.

Proximity and Related Words

Herein, the syntax of |a⇄b| denotes the (equivalent) notions of “distance”, “separation” or “proximity” between “a” and “b”, two points of interest (e.g. the locations of two APs) which may be (depending on the context) a direct measurement (“as the crow flies”, without regard to the road system or any detours that a vehicle cannot ignore; and sometimes called “Euclidean distance”) or a (nuanced) physical separation as traveled “on the road” (and in some scenarios, traveled “on the route”) between those two points of interest.

The syntax |a [symbol] b| denotes the general concept of proximity (i.e. without specifying the metric—whether “as the crow flies” or “on the road”). The symbol (uni-directional arrow) (e.g. |a→b|) denotes the proximity in the direction of travelling on the route from “a” to “b”. Depending on the context, both points are on the road/route or only one is or neither are.

“on the road”. “on the route”, “closest”, “next”

For modeling purposes explained below, an AP that is part of a Wi-Fi network and is located in a roadside venue or is otherwise located close enough to a road to include vehicular traffic passing through its coverage area (herein, its “Predicted AP Range”, explained below), is described as being “on the road” or similar terminology. Accordingly, expressions that are (explicitly or implicitly) based with reference to the road (such as, “ . . . next AP on the road”, and similar derivative expressions) are used herein.

Where a road (or portion of a road) is part of a route, the meaning of “on the route” includes “on the road” but an AP that is “on the road” is not necessarily “on the route”. How close an AP is to the road in order to be “on the road”, may be parameterized so that an AP located within a feet of the road, is considered “on the road” but not otherwise. The a parameter can be modified by the CWS Network system operator to improve or reduce granularity for calculations. An AP that is not “on the road” but is “close enough” to the road that a portion of the road is with its Predicted AP Range, may be considered relevant for certain calculation purposes, explained below). Examples of locations of APs “on the road” include a coffee shop facing the road, a retail sales store a small distance in from the road, a municipal Wi-Fi network or a privately operated WAN whose APs are widely and densely distributed among various venues blanketing parts of a road system.

The notion of “on the road” has two uses. First, it is used to identify which APs are relevant in the case of a Predicted Proximal Region being a line segment corresponding to a route (as elaborated below). Secondly, it used as a way of identifying which AP is the “closest” or “next AP” “on the road” when calculating the metric of |AP(i)−AP(i+1)| (as elaborated below).

The term “close” and related terms (such as “closer” and “closest”) is understood as measured by the direct physical distance (“as the crow flies”, without regard to the road system); or measured by the distance “as the vehicle travels” (to travel or has traveled, as the case may be), “on the road/route”). In contrast to the direct physical distance metric (e.g. from a simple calculation using geographical coordinates), the latter is a context-nuanced metric as it is affected by a plurality of other factors associated with vehicular travel on a road. These other road-derived factors include travel speed; the geometric aspects of the road (e.g. with turns and not necessarily straight); permanent “environmental artifacts” of travel on the road in certain places (e.g. prescribed speed limits, 4 (3,2,1)-way stops, roundabouts and one-way sections); and transient or episodic “environmental artifacts” of travel on the road, at certain times and places (for example, real-time surging human population densities and vehicle population densities, such as before/after a sports arena event, with corresponding usage of Wi-Fi and cellular networks); scheduled road repair; inferences of driver's intentions at an intersection (e.g. from vehicular gear selection and turn signals). All of these artifacts of “travel on the road” affect the metric of “distance” of travel “on the road”.

Which measure (direct, “as the crow flies”; or as traveled (or to be traveled, as the case may be) “on the road”; or both) is meant depends on the contexts explained below. In some contexts (explained elsewhere), there is a preference for the measure of “on the road/route” to identify the “next AP” because a vehicle necessarily will travel past an AP that is “on the route” (i.e. proximity to that AP is guaranteed at one point in the future travel, whereas the measure of “as the crow flies” may sometimes deceive because the route may turn from the AP that is, at one point in the travel, “close, as the crow flies”). But this preference may be switched depending on context and objectives of the CWS Network system operator.

AP Coverage

Every AP has a Predicted AP Range, modeled as a disc of radius R, and for simplicity of calculation and illustration in some explanations herein, it is assumed that the Predicted AP Range of each AP in a Predicted Proximal Region, is considered to be an identical disc of radius R (for the purposes of calculating Predicted AP Proximity, Predicted Spatial Overlap (PSO), and other metrics, as explained below). Realistically, as information is generated by operation of the APs over time, each AP can learn (or be taught by Mobility Manager 200 and/or the Wi-Fi network operator) through conventional learning techniques, to refine the accuracy of its Predicted AP Range (not just the physical range but its shape that was initialized as a disc). For example, the physical distance of an AP's Predicted AP Range is adjusted as a function of RSSI data generated historically.

Predicted Proximal Region (PPR)

An important conceptual primitive is the “Predicted Proximal Region”. Although a vehicular mobile node may have a disc-like radial reception coverage (for example, for listening for AP beacons), the movement of vehicular mobile node indicates that some parts of its radial coverage are more relevant than others, as time passes. The likely “Wi-Fi experience” or “AP experience” to be encountered is in the “future” that is ahead of the moving vehicular mobile node, i.e. the APs (or equally importantly, the lack of AP(s)) on (or proximate) the route to travel, are more relevant than the AP(s) “behind” or “lateral” to the vehicle. Even equipped with a directional antenna, vehicular mobile node wastes resources and time considering APs in its “rear view mirror”, as it were. True, “what's past is prologue” (Antonio, The Tempest); but equally true, the past cannot really be part of “what's coming”. An appropriate Predicted Proximal Region advantageously “focuses” the “attention” of the calculations onto the most relevant APs. Certain shapes are advantageous for certain road configurations in the road system (e.g. to smoothen unusual twists of the road to provide a more reliable metric on the expected AP experience, such as the large ellipse and triangles of FIGS. 10 and 11, as elaborated below).

Herein, a Predicted Proximal Region is the region (of APs) that a vehicular mobile node “sees” in its future as it travels (often on a route and always on a road, to provide direction). In the least, its velocity (speed and direction) are factors in its vision of the likely AP experience. Each Predicted Proximal Region has associated information about itself and the APs within it (the information being either pre-calculated in a permanent or semi-permanent way or calculated in real time for temporary purposes as vehicular mobile node moves, as explained below). That information is useful to decide if and when to select or remain with (or de-select and switch from) a Wi-Fi network relative to a cellular network (those two being two exemplary heterogeneous networks). Such information of the PPR includes the density of APs and related, such as Predicted Spatial Overlap (PSO), number of APs (NAPs), its shape and dimensions, location of APs with respect to each other and/or the roads (elaborated below). Put simply, the definition and use of a Predicted Proximal Region is important because it determines which APs to include (or ignore) in the network switching calculation.

The Predicted Proximal Region is a flexible concept in use. A PPR can be parameterized in several ways (depending on performance objectives and requirements, and (memory and computational) constraints), including the ways parameterized by “geography” and “shape”, as outlined for introduction, next, and then elaborated below.

Geography
eGeographically fixed (i.e. PPR is associated with a particular area of real world geography with artifacts)
   Square (grid) and non-square (e.g. triangle, rectangle, ellipse, other classical shapes; user-defined for artifacts on the ground—e.g. a rectangular-like ribbon that tracks the bends or turns in the road; irregular shape because of communications obstructions, such as restlessly dense foliage)
   OR
eGeographically dynamic (i.e. PPR is associated with vehicle and thus the AP information depends on its velocity and location at any given time, amongst other information)
   Square and non-square (e.g. triangle, rectangle, ellipse)

Shape

Each shape of (geographically dynamic/geographically fixed) PPR is:
static (i.e. retains shape and dimensions through time)

OR
alterable (through time and typically in response to velocity: deforms in dimensions (e.g. elongate or shrink), re-forms the shape (e.g. ellipse to circle), location of vehicular mobile node within the shape)

Other aspects of a PPR (such as orientation of the PPR relative to the vehicle and/or route, and the location of the vehicular mobile node within the PPR (i.e. Its internal location) are also explained below.

A Predicted Proximal Region (whether geographically fixed or geographically dynamic, and whether of a static shape or alterable shape, as elaborated herein) can be “virtually” defined by “geofences”. A geographically fixed PPR can be considered a “fixed geofence” (i.e. a virtual perimeter defining an area with real world coordinates); and a geographically dynamic PPR can be considered a “moving geofence” (i.e. a virtual perimeter defined around the travelling vehicle and vehicular mobile node). From the GPS readings of the location of vehicular mobile node and the real-world locations of APs, vehicular mobile node knows it has crossed or entered a geographically fixed PPR and knows (or will calculate to know) some information about the APs in the PPR; or it moves the geographically dynamic PPR as it moves, and knows (or will calculate to know) some information about the APs in the PPR (“moving geofence”). The “moving geofence” has its point of reference, the location of vehicular mobile node—as the node moves, its geofence moves (in the sense that it travels on the road/route, and in some contexts, may shift relative to the node so that the node's Internal location within the PPR shifts).

Geographically Fixed Predicted Proximal Region (PPR) Shapes

A PPR shape generally can be static or alterable. But for practical purposes (and economy of explanation herein), attention is paid to the geographically fixed PPR of static shape below. A geographically fixed PPR of alterable shape is conceivable—Instead of the fixed concatenation of four geographically fixed PPR squares in FIG. 9, the concatenation can be a moving fluid concatenation as the vehicular mobile node moves along the route, and depending on the speed and location and other environmental factors, the moving concatenation adding a geographically fixed PPR square that the node is approaching, and losing a geographically fixed PPR square that it has long passed). But the conceivable geographically fixed PPR of alterable shape so resembles the operation of a geographically dynamic PPR, that the explanations of the latter suffices to present the invention principles applicable to the former.

FIG. 9 shows two geographically fixed PPRs of static shape. One PPR shape is the straight line segment that corresponds precisely with the route (whose roads, as exemplary shown in FIG. 9, are straight line segments. The other shape is the plurality of squares that the route traverses. FIG. 10 shows a more nuanced and/or granular version of the square(s) and of the fixed concatenation of squares of FIG. 9.

FIG. 9 shows two locations, [A] and [E] (which may be the site of a car accident) and the route (rendered in solid dark arrowed line segment) therebetween which vehicular mobile node travels. Some of the roads not on the route are partially rendered in thinner line segments. Examples of a geographically fixed PPR static shape include a line segment that corresponds to (part of) a route; and a square (or sequential concatenation of squares) on a grid overlay of a geographical map of an area; both of which a vehicular mobile node travels on or through, as the case may be. These two examples are elaborated next.

The first, basic geographically fixed PPR of static shape, is the line segment. This single line segment corresponds to the route (and the underlying road of the route), co-extending with the route from start to end locations. A linear PPR is defined with information such as start and end locations (of the route), the length of (or distance traveled on) the route, and the number of APs (NAPs) on the route. From such information, the PSO can be calculated as the average separation between APs on the route.

The geographically fixed PPR of static shape of a line segment—the “linear PPR” may be the default PPR once a route is established (and note, one may not be, as explained below). What is explained below are more generalized and nuanced versions of the geographically fixed PPR of static shape, and may provide advantages beyond what the “linear PPR” can provide.

For example in FIG. 9, the geographically fixed PPR static shape of line segment corresponding to the route [A-E] can be implemented a linear geofence (where an AP is calculated to be “on the route” by reference to its a distance to that geofence (measured normal to the geofence). Each square corresponds to a geofence of dimensions (for example) 1 mile by 1 mile. When a vehicular mobile node is in a Predicted Proximal Region square, all the APs located therein have been factored (directly or indirectly, as explained below, Predicted AP Proximity) into the calculation of PSO for that Predicted Proximal Region. In FIG. 9, the route/linear PPR is shown as having a PSO of 10 (for illustrative purposes). As an example, suppose there are 40 APs on the route (NAPs=40), and there is a uniform Predicted AP Range for each AP. With such suppositions and with the distance of travel “on the road”, the Predicted AP Proximity(ies)s and PSOs can be calculated and stored in a database for easy reference. For example, the route may be a well-established routine one with locations [A] and [E] being primary and secondary hospitals and an ambulance (and its vehicular mobile node) may quickly consider such a route and its PSO of 10 for its context (e.g. in urgencies, Predicted AP Proximity and vehicular speed, Wi-Fi may not be suitable).

Another basic, geographically fixed PPR of static shape is the square. FIG. 9 shows a plurality of PPRs which are geographically fixed, each PPR being of a static square shape. The entire area managed by Mobility Manager 200 is layed out on a regular grid of square PPRs that is overlayed on a geographical area. Vehicular mobile node travels along the route, and in particular, traverses thereby the relevant PPR squares, in sequence. For example, in FIG. 9, each square has an associated/pre-calculated information e.g. AP density (normalized for the squares) for NAPs or PSO (with sample figures shown for some squares in FIG. 9, purely for illustrating differences of predicted AP experiences among the squares). A vehicular mobile node (provisioned with GPS functionality) knows that it is approaching the boundary of a (or the next, contiguous, “on the road”) geographically fixed Predicted Proximal Region square grid) square. If that square doesn't have certain minimum characteristics (e.g. the distribution of APs must satisfy certain metrics, e.g. it has at least PSOₘᵢₙ—explained below), it may consider starting (or remaining, as the case may be) on Wi-Fi (subject to other Contextual Factors). If the PTO is not sufficient (as explained below), then it should consider to switch to a cellular network.

These basic grid PPR squares can be organized into a larger organization unit which itself is a geographically fixed Predicted Proximal Region of static shape.

Also shown in the North-West corner of the map of FIG. 9 (with bold dashed borders) is the concatenation of four squares that are chosen to “cover” the initial part of the route from the start location [A]. This “super-squares” shape of a geographically fixed PPR, consists of the four squares for the vehicular mobile node to experience on the route as its likely AP experience: in sequence, the PSOs of <10, 14, 2, 14> (or a cruder metric of NAPs of <10, 14, 2, 14> or an even more basic metric of AP density of <10, 14, 2, 14>). The two, nearby squares with PSOs of 15, are not included in this larger Predicted Proximal Region because the route/road does not enter those two squares.

A PSO may be calculated for this larger Predicted Proximal Region (e.g. by averaging the four smaller square PSOs (i.e. average of {10, 14, 2, 14}=10) and then using such average PSO of 10, calculating the PTO for that larger Predicted Proximal Region. Alternatively, instead of an average, the smallest PSO (in the example shown in FIG. 9, PSO of 2) is used as the PSO for the larger Predicted Proximal Region as a conservative way to calculate PSO. Other ways will be obvious as an indicator of the AP experience likely to be encountered.

Note that the figures given to PSOs herein (e.g. PSO=10), are merely numbers for illustrative purposes (for example, to show relative differences in AP coverages/densities, these numbers are normalized). When implemented, the PSOs will have appropriate units of measurement.

As an alternative to the single PPR line segment corresponding to route [A→E], there could be the sequential concatenation of “mini-routes” of PPR line segments, <[A→B],[B→C],[C→D], [D→E]>, each PPR with its own PSO (not shown). The vehicular mobile node then travels through those “mini-routes”/PPRs, but with perhaps more granularity than the single PPR of corresponding to route [A→E].

Alternative to the linear and square shapes of geographically fixed PPRs (of FIG. 9), a variety of other static shapes of geographically fixed PPRs, is shown in FIG. 10. Instead of using PPR line segments, differently shaped geometric shapes are advantageously defined and combined to cover the entirety of route [A→E] to provide more accuracy of PSO(s) therealong. An illustrative combination is shown in FIG. 10. The route from start location [A] to end location [E] is generally south-easterly and is covered by the sequential concatenation of: first, rectangle [A to B](with PSO of 12) that “hugs” the road; secondly, ellipse or oval shape [B to C](with PSO of 10); thirdly, a curved version of a rectangle, akin to a “road hugging ribbon” that hugs the road with a slight bend [C to D] (with PSO of 7); and lastly, a Predicted Proximal Region of triangular shape [D to E] (with PSO of 3). Thus, in the example of FIG. 10, vehicular mobile node experiences decreasingly dense AP regions (i.e. decreasing PSOs) as it travels from [A] to [E]. Coupled with other information (e.g. such as NAPs, etc), PSO and PTO may be calculated for the switching decision between Wi-Fi network and cellular network. Decision can be made on a per-Predicted Proximal Region basis; or can decide on an overall basis (e.g. by average all the PSOs (12, 10, 7, 3) for the entirety of the route [A to E], perhaps (or not) weighing each PSO by the “on the road” traveled distance. The preceding calculations likely will result in a different predicted AP experience than using the geographically fixed PPR of line segment corresponding to the route [A-E] in FIG. 9 that was given a PSO of 10, for illustrative purposes (based on a single calculation for the entire route [A] to [E]). Just as an illustrative example, the sequence of PPR squares of FIG. 9 that a vehicular mobile node traverses, does not include the APS in the squares of POS of 15 (in the North West area), whereas the PPR rectangle [A-B] in FIG. 10 might include some or all of such APs

To be contrasted is the PPR ellipse [B-C] of FIG. 10 with PPR ribbon-like rectangular shape [C-D], and/or with traversing the PPR square grids of FIG. 9. PPR ribbon strip [C-D] hugs and tracks the route/road—every curve/turn of the road/route is reflected in a contour change of the ribbon strip. Similarly, every turn/curve of the road/route is recognized by the inclusion of a PPR square grid (even if the route/road enters that square only very briefly, perhaps a few seconds of travel in a corner of the square, such as the square with PSO of 2, in FIG. 9). In contrast, a PPR that is defined and calculated to look further forward along the route and to obtain a general direction, might be more reliable in the prediction of “AP experience” than a PPR that is immediately responsive to every turn on the road even if the net result of small turns does not affect the overall trajectory of travel. For example, with reference to FIG. 9, a vehicular mobile node travelling southerly would experience PPR squares of decreasing PSOs of <16, 5, 3, 3, 3> (in FIG. 9)—but travelling further, would turn a corner and continue easterly, would see the higher PSOs of <16, 5, 3, 8, 14>. If the PPR shape is an ellipse (classically defined) or ellipse-like (as user defined). This shape may be suitable where the road/route presents a plurality of turns but does not change its overall direction (see FIG. 10 and the ellipse-like Predicted Proximal Region between points [B] and [C], where the Predicted Proximal Region [B-C], is generally directed South-Easterly). Overall, the ellipse [B-C] with a PSO of 10 (shown in FIG. 10) may be more accurate for the [B-C] part of the route than using concatenated squares (of FIG. 9) or by any other shape that tracks the road turns too closely. In other words, too granular a shape that tracks too closely the route, may prematurely discount or enhance the predicted AP experience.

Geographically Dynamic Predicted Proximal Region (PPR)

As seen in FIG. 11, a vehicle with vehicular mobile node, is notionally headed (represented by [symbol] ) on an easterly directed route (not shown for simplicity of illustration). The designated locations of AP1 to AP8 are not drawn to scale in FIG. 11 but are located for illustrative purposes only to show the relative locations of APs with respect to each other and to the vehicle. In FIG. 11, the notational identifications of AP1 to AP8 are merely for numbering and do not necessarily denote or connote any sequential relationship therebetween (with the exception of AP1 and AP2, where the vehicle is on the route/road (not shown) to AP1 and then, next on the route/road, AP2). It is evident that differently shaped Predicted Proximal Regions will include (or not) different APs (so that variables like NAPs and AP density, PSO, PTO and other calculations in a Predicted Proximal Region will change as vehicular mobile node moves).

Each (geographically dynamic) PPR shape (whether the shape is alterable or static) (with examples of rectangles, triangles, ellipse and circle) corresponds to a “moving geofence” that is calculated by vehicular mobile node or Mobility Manager 200 in real time. When a vehicular mobile node is in a moving Predicted Proximal Region, all APs located therein at the time of calculation of PSO, PTO (and other metrics) are factored (directly or indirectly) into the calculations. But as vehicular mobile node (and thus the PPR) moves, some APs are “left behind” and excluded, and “new” APs are included in the PPR for future calculation purposes. (and where the PPR shape is alterable, the geofence itself changes shape as function of, for example, speed and other artifacts of the physical and communications environment.

As the vehicle travels, a Predicted Proximal Region's geographical coverage changes as vehicular mobile node travels, whether its shape is static or alterable. FIG. 11 shows a variety of geographically dynamic Predicted Proximal Region shapes (each one a “moving geofence”). Such PPRs may be configured to be a static shape (i.e. retains its shape as the vehicle moves) or an alterable shape (i.e. morphs or “shape-shifts” as the vehicle moves).

Static Shape

Predicted Proximal Region-Triangle Δ1 (static) 600 covers {AP1, AP2, AP6}, i.e. NAP=3. This triangle shape is an isosceles triangle, with the vehicular mobile node at the apex and so this triangular PPR represents the expected experience of APs were vehicular mobile node to continue on its route easterly. As a static shaped Predicted Proximal Region, Triangle Δ1 600 retains its shape and dimensions as it moves. Later, vehicular mobile node has moved easterly, and correspondingly, PPR 600, has then moved (as represented by dashed triangle Δ1a 600 in FIG. 11) and while it has retained coverage of AP2, it has “lost” coverage of AP1 (i.e. vehicular mobile node has passed AP1 on the road/route and moved forward to the point that AP1 is no longer covered and so any calculation for PPR 600 (e.g. for NAPs, PSO, and the like) no longer includes AP1; and similarly, also has “lost” AP6; but does, by then, include {AP2, AP3, AP5 and AP8} so that the NAPs of PPR 600 at that later time, has increased to 4, etc. (i.e. AP3, AP5 and AP8 will then be included in any calculations for PPR 600).

Alterable Shape

The morphing or deformation may be dynamic so that Predicted Proximal Regions change dynamically (in shape, dimensions and location). As the vehicle increases or decreases speed (beyond some prescribed levels), the (forward, rear, lateral) dimensions of the geometric shape elongated (or shrinks as the speed decreases), thus covering more (or less, respectively) APs.

For example, what started as a triangle, may morph into an ellipsoid and then into a circle depending on the reduction of vehicle speed and other information (intersection/traffic lights/turn signals).

A geographically dynamic Predicted Proximal Region shape may be dynamically alterable to the extent that it changes dimensions (while essentially retaining its shape). With reference to FIG. 11, Predicted Proximal Region-Rectangle □1 shape can be configured to be static or alterable.

As a static shape, this PPR Rectangle □1 610 is of fixed dimensions (of length and width) and, as shown in FIG. 11, covers {AP1, AP2 AP3}. As vehicular mobile node travels easterly, PPR-static rectangle 1 will “lose” AP1 but might “cover” APs (not shown) that are easterly of AP3.

PPR-rectangle □1 may be configured to be dynamically alterable to deform by changing its dimensions in response to changing contextual factors such as vehicular speed. For example, from an initial length, and relative to an initial speed, the rectangle shrinks longitudinally as the vehicle increases speed substantially, and/or elongates as the vehicle slows substantially. The result of a shrunk rectangle 1a is shown in FIG. 11 where the easterly, distal end 611 is shown in a “long dash dot” line so that only {AP1, AP2} are covered. The extent and direction of deformation is a design choice (which is easiest to understand in the case of a generally longitudinal shape) that is influenced by Contextual Factors of application requirements and objectives, and cost (of cellular network coverage) and/or the methods of predicting PTO (and in particular, the method of approximating Predicted AP Separations, as elaborated below). In particular, the particular approximation method (and its use and scoring of APs in its calculations) is important. For some methods, the faster the speed, the “closer” APs are more important for calculating PSO and PTO and so the rectangle is sensibly shrunk (to exclude the more distant APs). And for other approximation methods, the faster the speed, the further forward a Predicted Proximal Region should extend (i.e. to predict the “AP experience” that will come sooner than later); and conversely, the slower it travels, then the more distant APs are not as relevant to predict the “AP experience”, and the Predicted Proximal Region should shrink (in the forward dimension).

And also, if the objective is to take a longer range view of the expected “AP experience”, then in case of a straight road, speeding up implies elongating the rectangle.

(In fact, if the slowing down can be associated with some other information of the driver's Intentions, such as dramatic deceleration, gear selection and turn signals, the inference could be made that the driver is considering whether to turn, and the dimensions and shape of the Predicted Proximal Region may be dynamically adjusted.

A geographically dynamic Predicted Proximal Region shape may be dynamically alterable to the extent that it deforms into a different shape that is more advantageous for the contextual factors applicable changing in real time, especially vehicular speed. Consider in FIG. 11, the alterable ellipse 630 covering {AP1, AP2, AP3, AP6, AP7}. Suppose the vehicle has slowed to stop, and the gear selection and brake status remain for potential movement, and the vehicle turn signals status is non-committal. The PPR shape is configured (as a function of speed) to smoothly morph into a circle (rendered in a dashed line) upon reaching zero speed (with the motivation to alter to a circle being based on the inference that the vehicle (driver) may be considering to turn (or even reversing), or may be pausing for some personal reason and may simply continue on its easterly path/route). Whereas PPR ellipse 630 covers {AP1 and easterly of the vehicle, AP2, AP3, AP6}, PPR circle 631 (shown in dashed lines) covers {AP1 and laterally of the vehicle, AP4 and AP7}.

In contrast to the coverage of aforedescribed geographically fixed Predicted Proximal Region-Triangle Δ1 (static) 600 covering (AP1, AP2, AP6), that is appropriate for a vehicle mobile node moving easterly, Predicted Proximal Region-Triangle Δ2 (static) 620 can be considered loosely as a “flipped” version of PPR Triangle 600 that covers {AP1, AP4, AP7}. The “base” of Triangle Δ2 620 is behind vehicular mobile node; and PPR 620 does not “look forward” (as PPR 600 does) as much as it “looks laterally”, to both sides of the vehicle. This PPR shape, Triangle Δ2 620, might be appropriate for some transitional or “boundary conditions” environment of vehicular mobile node. For example, the environmental contextual factor might indicate that the vehicle has stopped at an intersection with traffic light/congestion with the gear selection not being “park”, and that the turn signal have not yet been activated. It is inferred that the driver is hesitating and thinking of turning onto a secondary road or may be waiting for the traffic light to turn green to continue easterly. In that situation, a switch (or gradual shape-shifting—depending on the speed or deceleration of the vehicle) of PPR shape from Triangle Δ1 600 to Triangle Δ2 620 is appropriate (recognizing that {AP2, AP6} are of less predicted relevancy in that situation. When the vehicular mobile node leaves the transition phase (e.g. turns northerly), then another PPR shape (parameterized by speed, orientation, dimensions, etc.) is chosen.

Alterable—location of vehicular mobile node within the shape.

Geographically dynamic PPR ellipse 630 may be alterable and configured to deform/morph into a circle. It is configured to decrease its major axis and increase its minor axis as the vehicle slows (i.e. creating a shorter, “fatter” ellipse), and then shifting relative to the vehicular mobile node, so that the node find itself moving towards the center of the “fatter” ellipse, thereby pick up fewer APs forward of the vehicle and more APs lateral of the vehicle. As shown in FIG. 11, vehicular mobile node starts near the rear focal point of PPR ellipse 630, whose major axis is oriented in the direction of travel of the vehicle. As the vehicle slows down, the ellipse may “shape-shift” (shrinking its major axis and increasing is minor axis) into a circle (as shown as circle 631 in dashed lines in FIG. 11); and vehicular mobile node gradually finds itself, relative to its shape, in the center of PPR circle 631.

References herein to Predicted Temporal Overlap (PTO), Predicted Spatial Overlap (PSO), Predicted AP Range, Predicted AP Proximity(ies), Number of AP(s) (NAP(s), are in respect of a given Predicted Proximal Region (whether a fixed portion of the geography, such as a grid square overlayed on a map, or a portion dynamic in its location and its geometric shape). Different Predicted Proximal Regions (even contiguous ones) may have very different PTOs.

An introductory example is presented next for a simple case, with more generalized versions later.

Another geographically fixed PPR static shape is the square.

FIG. 9 also shows the map covered by a plurality of grid squares, each with its (pre-calculated) AP density/PSO (explained below). The Predicted Proximal Region shape is fixed geographically (i.e. as a square imposed on real world geography), and the route [A→E] traverses squares of PSOs of {10, 14, 2, 14}(starting at [A]) and so on to {5, 5, 6} (terminating at [E]). A vehicular mobile node enters each PPR square and leaves it to the neighboring square, fixed Predicted Proximal Region or perhaps starts a geographically dynamic Predicted Proximal Region, explained below).

The decision to continue with Wi-Fi or to switch to cellular network coverage (and vice versa), is based on relationship between the background scanning interval (BSI) and the Predicted Temporal Overlap (PTO).

Predicted Temporal Overlap (PTO)

The calculation (and possible adjustment) of PTO are explained next. The calculation (and possible adjustment) of BSI are explained after that.

This invention covers an elaboration of the environmental contextual factor(s): as explained above, of permanent and transient, episodic artifacts of travel on the road; of vehicular location (that might be pertinent to public and/or private infrastructure Information to use in vehicular mobility and wireless mobility decisions, both permanent artifacts (such as 4-way stops, roundabouts and one-way sections of the road) and episodic information (such temporary construction site closure of a road); of vehicular velocity (speed and direction); of inferences of driver's intentions (e.g. from vehicular gear selection and turn signals); and of the (predicted) presence of upcoming AP(s) (and which may involve the Network Health Assessment or Authority 210, Network Health information and reports, Mobility Manager 200, and an inference from its historical travels). A main (but not the only) emphasis of this invention is the predicted presence of upcoming APs, as nourished by information and constraints from elsewhere (from vehicular mobile node background scanning characteristics in Wi-Fi to the contextual factor of application requirements).

The “predicted temporal overlap”, or PTO, is the expected time that a vehicular mobile node will enjoy while being associated with an AP but looking for re-association with a “neighboring” AP (or more specifically, the “next” AP predicted to be upcoming on the road/route traveled, whether that AP is on the road/route or is nearby measured directly, “as crow flies”). Considered more generally, PTO is an indicator/predictor of the “quality” (and quantity/density) of AP experience that a moving (especially but not necessarily vehicular) mobile node can expect to encounter and is a factor to consider when switching between networks in a heterogeneous network situation. If the PTO is zero (or negative), then re-association with the “next” AP is predicted to be unlikely and so switching to a cell network is implicated. An “acceptable PTO” is one whose value is at least PTOₘᵢₙ which is set to be at least zero, and whose value may be set high enough for confidence in Wi-Fi communications (considering application requirements and other contextual factors). PTO=(R1+R2−Predicted AP Proximities)÷speed.

PTO is a predictor of the “quality” of AP coverage that a mobile node can expect to “experience” in the future. Accordingly, an AP that the mobile node has “passed” on the road (in the absence of contra-indications like turn signals being activated, gear selection being “reverse”, and the like), is unlikely to contribute to the PTO, and in fact, its inclusion would adversely distort the PTO.

In particular, the PTO (for a vehicular mobile node vehicular mobile node) is related to the density of, and geometric distribution of, APs, as counted (or not) in the PPR that it is in (or will enter). In particular, it is related to the “spatial overlap” of upcoming APs, which can be converted into “temporal overlap”, which can be compared to vehicular mobile node's scanning characteristics (explained elsewhere) and thus an intelligent switching decision can be made moving through heterogeneous networks, and scanning characteristics can be modified.

Calculations Related to PTO and BSI

In a Wi-Fi-based system, the “background scanning interval” or “BSI” is the interval between background scans conducted while a vehicular mobile node is associated with an AP and is otherwise passing data traffic. Although not specified in the IEEE protocols, “background scanning” and BSI, are established concepts and realities in the Wi-Fi eco-system.

Calculate PTO and BSI and continue with (or switch to) Wi-Fi if the following are true:

I. PSOₘᵢₙ is satisfied

II. BSI>BSIₘᵢₙ

III. PTO>2×(BSIₘᵢₙ+ST)

Otherwise, look for (or remain with) cellular network coverage.

Condition I is a threshold condition (it is useful but not strictly necessary, and is elaborated below).

Condition II is required because of application requirements (as elaborated below).

Condition III is introduced next but BSI will be elaborated on below. For good switching performance between Wi-Fi and cellular networks (and in particular, to allow enough time for two complete scans within the PTO):

PTO≧2×ScanCycleTime

where ScanCycleTime=ScanTime (ST)+Background Scanning Interval (BSI) ScanTime (ST) is the amount of time required to iterate through all instructed channels to scan.

How to Calculate PTO.

For a given Predicted Proximal Region, the Predicted Temporal Overlap (PTO)=Predicted Spatial Overlap (PSO)÷velocity≈Predicted AP Proximities÷speed or

PTO≈((Predicted AP(i)Range+Predicted AP(i+1)Range))−(Predicted AP Proximities)÷speed

Predicted Proximal Region is the geographic region of predicted/likely interest to vehicular mobile node. In particular, it is the region that has AP(s) (or in the worst case, no APs) that are (and predicted to be) proximate to vehicular mobile node as it moves forward (always on a road, and sometimes, along a route).

“predicted AP proximities” is a main Indicator of the predicted quality of experience between APs in the Predicted Proximal Region. Several approximation methods for that indicator are presented (from modeling by geometric uniform distributions of the APs (or at least, distributions which exhibit high levels of internal symmetries) in the Predicted Proximal Region, based on analogous and known geometric distribution of shapes) to finding the largest separation of two APs), and variations).

For the purposes of calculating Predicted AP Proximities for the (then applicable) PPR, let AP(i) be the AP that vehicular mobile node is currently associated with. For simplicity of explanation and modeling, AP(i) can be considered “on the road/route” of vehicular mobile node (although this is not necessarily true in reality). Being within the coverage area of AP(i), vehicular mobile node is moving towards AP(i) or has recently passed it on the road, all within the (then applicable) PPR. The next AP “on the road” (were the vehicle to continue travelling on the road/route, and vehicular speed, turn signals, etc. do not provide a contra-indication to continuing on the route) is AP(i+1). In the general case, these two APs are not necessarily on the same road and the road therebetween is not necessarily straight. But for simplicity of illustration in some explanations below, the focus is on, as a key metric, their closeness.

Threshhold—calculation of PSOₘᵢₙ

Upon entering a PPR (or looking into the next candidate PPR), and considering the first AP and second APs in a PPR, most important is the separation/distance between AP(1) and AP(2) (herein, denoted |AP1⇄AP2|).

As long as (Predicted AP1 Range+Predicted AP2 Range)>|AP1⇄AP2|, this basic threshold is satisfied in expecting linear spatial overlap between coverage of AP1 and AP2, in the sense of a straight line segment therebetween. The less |AP1-AP2| is (i.e. the more proximate AP1 and AP2 are), the greater is PSO (and correspondingly, the greater will be the PTO to be enjoyed between AP1 and AP2 by vehicular mobile node for Wi-Fi purposes). Let PSO_{min . . .} be, at least, the satisfaction of the relationship of (Predicted AP1 Range+Predicted AP2 Range)>|AP1⇄AP2|.

In the square grid of FIG. 9, AP1 is the current associated AP. As vehicle is about to leave a square grid, a calculation is performed (by Mobility Manager 200 or vehicular mobile node), to look for AP2, the “nearest” AP, forward on the same road or “as crow flies” in a “neighboring” PPR grid. If |AP1-AP2| is insufficient, for the then speed of vehicular mobile node, for PTOₘᵢₙ, i.e. |AP1-AP2<(Predicted AP Range of AP1+Predicted AP Range of AP2), then consider a switch to the cellular network.

After satisfying the threshold of PSOₘᵢₙ, the inclusion of additional APs, i.e. {AP3, AP4, and so on} in a Predicted Proximal Region (especially as the vehicle moves past AP1), in the calculations (for example, of PTO), will not degrade the proximity of |AP1-AP2; and with some/many locations of {AP3, AP4 and so on} in the PPR, the AP-denser Predicted Proximal Region, will “enhance” the PTO.

Knowledge of AP Locations

The geographical, “real world” location of every AP must be known as part of initialization. All approximation methods for Predicted AP Proximities require such knowledge, when the use thereof may be at different times and for different purposes. Method no. 1 must know (or be taught) know those locations to determine NAP (as part of its calculation for Predicted AP Proximities so it can give a pre-calculation of PSO for each (geographically fixed) PPR. The other methods require knowledge and re-use of such knowledge to do real-time (or near real-time) calculations.

Method 1 (making a notional geometric distribution of APs in a PPR) requires the AP locations initially in order to determine NAPs for a PPR, i.e. count APs (i.e. to include or not) the number of APs that are in a PPR shape (e.g. square) (or in the case of the PPR shape of a line segment, to determine whether an AP is “on the road/route”). Once NAPs is determined for a geographically fixed PPR static shape, the locations of the APs are not thereafter used (until the next recalculation, e.g. because of Network Health Assessment 210—in particular, an AP is disqualified (having received a negative report on it; or has returned to health, and now becomes a candidate for inclusion in a PPR, in particular, and as a candidate for a mobile node to switch to). In contrast, methods 2 and 3 repeatedly require such knowledge and use of the exact geographic locations of APs, especially for geographically dynamic PPRs (i.e. as the PPR moves, the inclusion and loss of APs in the coverage area, must be calculated frequently).

For each Predicted Proximal Region, the “Predicted AP Proximities” (or “Predicted AP Proximity”, as the case may be) is calculated. Three approximation methods are described below (in approximately increasing requirement of resources (knowledge, temporal, computational, and the like). The methods are employable for a geographically fixed or geographically dynamic PPR (static or alterable shape). As noted above, a geographically fixed PPR's shape is typically static and so the alterable shape will be ignored herein, for economy of expressions—in essence, the “super-squares” concatenation can be extended on a rolling basis forward as a function of vehicular speed but this resembles a geographically dynamic PPR which is explained herein.

Approximation Method 1

Modeled uniform/symmetric/average geometric distribution of APs therein to calculate PSO. NAPs, locations of the APs, geometric information for the PPR is required but the locations of the APs is not required after the initial calculation of PSO for a geographically fixed PPR of static shape.

Approximation Method 2

If the locations of AP1 and AP2 are conveniently usable, the NAPs for the PPR is known but the locations of the other APs are not conveniently known/usable, then |AP-AP2*| is a simple calculation for insight into the “AP experience” for that PPR. AP2* is AP2 notionally multiplied (directly or indirectly) by a factor β that takes into consideration the existence (or not) APs after the first one in a Predicted Proximal Region and the presence of “environmental artifacts” (transient or permanent). The more APs in a Predicted Proximal Region (i.e. the more AP density), the “more” spatial overlap (PSO) is predicted to be experienced by vehicular mobile node moving through the Predicted Proximal Region, which translates into more “temporal overlap”.

Approximation Method 3

If the locations of all APs are known, then try to build a “circuit” (complete or not) for average/greatest of all APs proximities to calculate PSO.

In the above approximation methods, the concepts of “neighboring AP”, “closest neighboring AP”, “next AP”, whether measured “as the crow flies”, or as “next one in the direction of travel on a route”. There is a preference to APs which are “next on the route” (because a vehicle will certainly stay on the road/route and pass very closely to that AP, but may not ever travel very closely to an AP not on a road but in fact, the road may be turning away from such an AP) but sometimes, that preference is misplaced (because of unusual and local twists of the road), so there is a way of reconsidering if the track-road doesn't work.

Approximation Method 1

In the absence of sufficient resources (computational, time and/or use of the locations of all APs in a Predicted Proximal Region), this first method notionally “locates” the APs to permit a simple calculation.

The basic primitive in this (first) approximation method is the (spatial) relationship between two notional APs in a geometrically “uniform” distribution of all APs in the PPR.

The simplest case is the (geographically fixed) PPR of (static shape of) the line segment. Linear PPR extending with route [A→E]. In FIG. 9, it shown with an exemplary (pre-calculated) PSO of 10. (This PSO number is just a number for illustrative purposes herein; in implementation, the actually metrics used will be calibrated for real world factors). The pre-calculation considers the distance of the route [A→E] (i.e. |A-E|), the number of APs on that road/route/line segment and assumes that each such AP has the same Predicted AP Range of radius R and notionally locates them at equidistant separations (or proximities) on such line segment. From such information, the Predicted AP Proximity (i.e. the average separation between APs) for route [A→E] is PPR-line is |A-E|, and from there, Predicted Spatial Overlap (i.e. the PSO between APs on route [A→E] is easily calculated).

This simple, linear case inspires a generalization to 2-D shapes of PPRs. After determining which APs are in a given 2-D shape, an “average PSO” can be obtained by notionally locating those APs within the shape in a geometric distribution where the uniformity of separations between APs is maximized, which comes from maximizing the symmetries therebetween (thereby rendering the “average PSO” to be a figure that is as realistic a representative Predicted AP Proximity for the entire PPR).

Consider the 2-D shape of a square.

Packing “n” (unit) circles into the smallest square (or equivalently, arranging “n” (AP) points in a square with largest minimal separation) is well established mathematically (with published computations of geometric distributions of locations for n<=10,000). The mathematical problem of circle packing in a square does not map exactly to formulating the most (or absolute, if possible) uniform overlap of the discs but the established geometric distribution (for packing circles in a square) are conveniently suggestive of geometric distributions with symmetries that have uniform separations and thus, making a simple average of separations/proximities, a realistic way of “locating” the APs for the purpose of computing PTO.

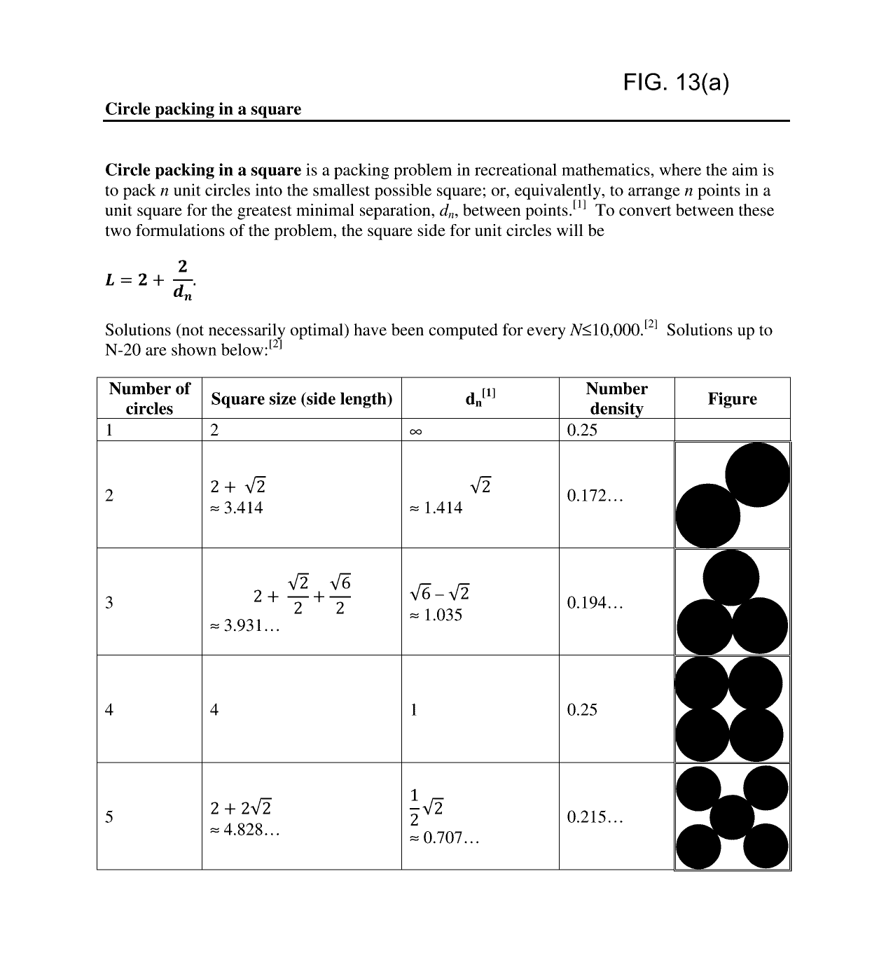

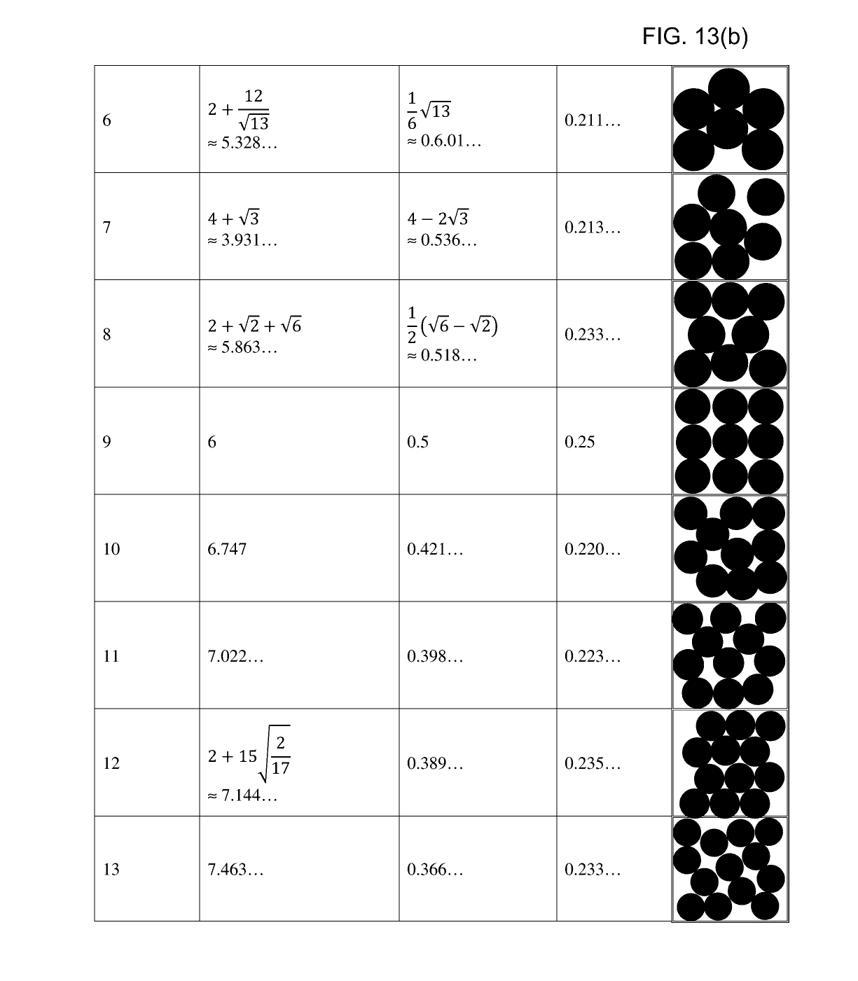

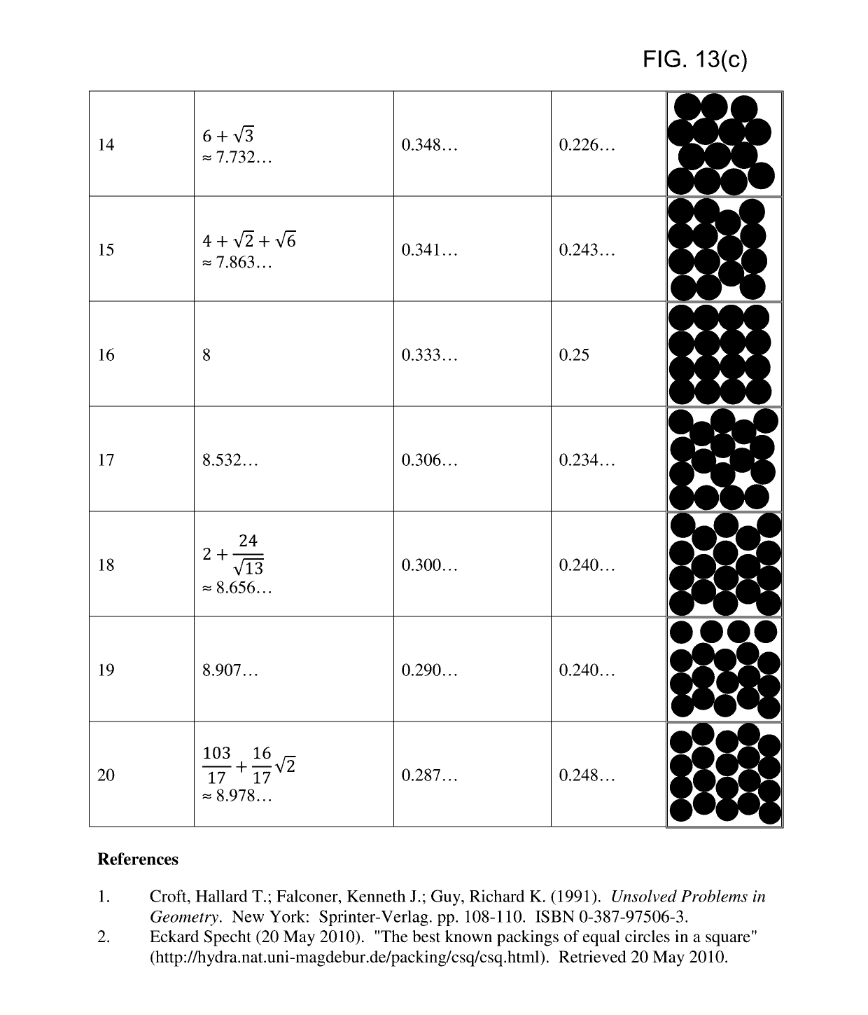

For n=2 to 20, see FIG. 13. For larger n, published computations are publicly consultable.

Note that the proximities/separations are not precisely uniform. There is uniform proximities for n=3 (i.e. triangle) but in Euclidean 2-space, there is (likely) not a geometric configuration with uniform separations for n>3. That said, for n=4 (and squares like n=9, 16, 25, and so on), the (filled) “square” configurations (see FIG. 13) provides for proximities/separations that are approximately uniform and, accordingly, an average (averaged among each AP and its “neighbors”) can be realistically calculated. For n=5, 6 and others, which can be modeled as concatenations of n=3 triangles. Generally, reference to FIG. 13 configurations . . . .

For a square of given dimension, NAPs, and Predicted (or Average) AP Range, the APs can be notionally arranged according to the above mentioned geometric configurations, and the “average” overlap (of APs coverage) can be calculated, with the “average” being (or close to) the “uniform” overlap between neighboring APs (in some symmetric configurations).

One can extrapolate for NAPs in between the “simple geometries” noted above for NAPs which are square (i.e. n=4, 9, 16, 25) (explained below).

Instead of using the geometric configurations as shown in FIG. 13 for n=NAPs n=5, 6, 8, other geometric configurations are advantageously possible and depending on the other factors learned of the Predicted Proximal Region, those other geometric configurations may be more realistic and can be obtained by conventional iterative and learning techniques.

The preceding is for the shape of the square. For Predicted Proximal Region shape that is a non-square (e.g. rectangular, triangle or ellipse), the uniformity of notional locations of APs is more difficult to approximate/model in the sense that there may not be published suggestions for every conceivable non-square shape. For sure, some packing questions are well investigated (often under the rubric of “recreational mathematics”—for examples, packing circles in rectangles, packing a triangle with sub-triangles, packing larger shapes using triangles) to maximize symmetries, especially using equilateral triangles as sub-units which have inherent uniformity of separations of vertices. For an irregularly, user-defined PPR shape, the use of known packing geometries to suggest geometric distributions, can be used to produce internal symmetries and uniformity of separations, to the fullest extent of such irregular shape with known distributions, and with the remaining residual areas being populated with notional APs in iterative optimizations.

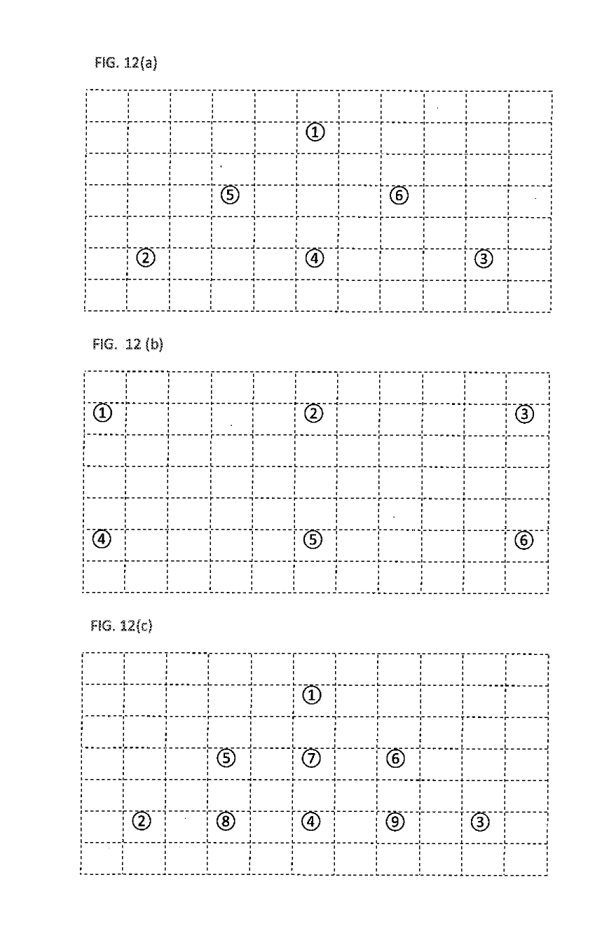

An exemplary geometric distribution of (notionally placed) six [AP1] to [AP6] in a PPR represented by a rectangle of (notional) dimensions 7×10, is shown in FIG. 12(b). The [AP] notation means that the AP is notionally located in a given geometric distribution, which may or may not resemble their real world geographical locations within that PPR.

Proximities are measured in two ways, as described next.

If the proximities (“closest”, “next”) are measured directly (“as the crow flies”), then, NAPs=6 for this PPR, and [AP1]'s closest neighbor (CN) is [AP4] because it is the closest compared to [AP2] and [AP5], and so on. The average of {([AP1]-its CN|, |[AP2]⇄its CN| . . . |[AP6]⇄its CN|} is 6/6=1. The largest of {[AP1]⇄its CN|, |[AP2]⇄its CN| . . . |[AP6]⇄its CN|} is 1. Note that [AP]x's closest neighbor may be [AP]y but the converse may not be necessarily true—it depends on the geometric distribution/configuration of the [APs] and the measure of |a-b| (which may be |a→b|). Here, the predicted [APs] proximity is the largest [AP] proximity and is also the average [AP] proximity.

If the proximities (“closest”, “next”) are measured by the distance to travel “on the road” (route), then suppose that [AP1], [AP2] and [AP6] are notionally anad sequentially located on the road/route (the road/route is not shown for simplicity of illustration). When proximity is measured by “travel on the road”, this Predicted Proximal Region has NAPs=3 in the (directional)“line segment” connecting [AP1]→[AP2]→[AP6], viewed by “travel the road”). Then [AP1]'s CN is AP2; [AP2]'s CN is [AP6]; and [AP6]'s CN is [AP2]. Then Predicted AP Proximities can be the average of {|AP(i)-AP(i)_{closet neighbor}|} for i=1 to NAPs=3, and AP(i)_{closet neighbor} is the AP that is closest to AP(i) travelling that road. CN=closest neighbors.

Thus it is readily seen that average proximity (or “most proximate” or related) provide different refinements/realistically, and that the metric used (directly or traveled on the road”), leads to different refinements.

The choice of PPR shape may be calculated by vehicular mobile node based on a plurality of factors, including contextual factors and information about the road system, the route, locations of APs relative to each other and the road system, nature of the neighborhood, vehicular speed, and many others herein described. For example, if the portion of the route is a grand boulevard with many side roads and alleys parallel thereto, each lined with many coffee shop Wi-Fi networks, then an appropriate PPR shape is a rectangle. And within the rectangle, for method 1 of approximation of the Predicted AP Proximities, the choice of a model geometric distribution may be influenced by “real world” physical or other factors and artifacts related to the area traveled, so that for such grand boulevard and Wi-Fi equipped cafes, for NAPs=6, a rectangular geometric configuration of two parallel rows of three APs each might be suitable, as shown in FIG. 12(b). And if the road runs through an area that has no interesting artifacts that affect Wi-Fi communications, then perhaps an equilateral triangular geometrical distribution would provide more uniform separations/proximities between neighboring APs, as shown in FIGS. 12(c) and 12(c) for method 1 of approximating Predicted AP Proximities.

For NAPs, n=7, 9, 10, 11, 12, 13, 14, 15 and so on, the average predicted AP proximities can be extrapolated between the average overlaps calculated for the “squares” (i.e. n=4, 9, 16, 25 and so on) and their accuracy can be improved over time through an Iterative process that gathers and factors in more information about the APs and their Predicted AP Ranges, for example.

Above was to use a (relatively) uniform model of geometric distribution for a Predicted Proximal Region of a square. The same method can be applied to a Predicted Proximal Region of non-square shape. For example, for a geographically dynamic Predicted Proximal Region whose shape is an equilateral triangle (for example, triangle Δ2 620 shown in FIG. 11), then the geometric distribution model is a combination of three equilateral sub-triangles. A precisely uniform separation could be obtained by distributing the [APs] in equilateral sub-triangles. As shown in FIG. 12(c), the (larger) equilateral triangle (with vertices at Δ[1,2,3]) can be composed of eight identical equilateral sub-triangles (Δ[1,5,7], Δ[1,7,6], Δ[2,5,8], Δ[5,8,7], Δ[4,8,7], Δ[7,4,6], Δ[4,9,6] and Δ[6,3,9]) and so with a notional AP at every vertex of every equilateral sub-triangle, separation/proximity between every AP with all of its closest immediate neighbors, is uniform. Other shapes can be composed by a combination of equilateral triangles and squares and user-defined shapes for which there is already good knowledge of the “AP experience”; i.e. a PSO that is the result of historical iterations of notional geometric distributions of APs to provide (near) uniform geometric distributions for a given NAPs in a given geometric boundary of a PPR shape.

Approximation Method 2

The basic primitive in this (second) approximation method is the (spatial) relationship between the first AP (the one that vehicular mobile node is currently associated with, so that it is approaching it or has just passed—on the road) and the second AP, along the route (or as crow flies).

The basic primitive in this (second) method is the proximity of AP1 and AP2, i.e. |AP1⇄AP2|. This method focuses on the “first two” APs in a PPR (denoted AP1 and AP2), and in particular, their separation/proximity of |AP1→AP2|. Those two APs are of the most immediate relevancy to vehicular mobile node. AP1 is the appropriate first reference point as the first/immediate AP of importance (either as the first AP to encounter); and AP2 is important as the next candidate after AP1 where candidacy is measured as traveled “on the road” or “as crow flies”. Other APs in the PPR (if any) are important but their relevancy increases only in the farther future of travel.

For simplicity of explanation and modeling, AP1 is the AP on the route that vehicular mobile node is currently associated with. Being within the coverage of AP1, vehicular mobile node is moving towards AP1 or has recently passed it. AP2 is next on the route (again, for simplicity of explanation and modeling, assuming the vehicle to continue travelling on the route, and where other contextual factors (examples include speed, turn signals, and the like) do not provide contra-indications that vehicular mobile node will not continue its trajectory on the route. Depending on the context, especially when traversing a plurality of geographically fixed PPR squares (of FIG. 9), AP1 or AP2 may be the first AP in a candidate, neighboring square that the vehicular mobile node has not yet entered).

In a more general case, AP1 and AP2 are not necessarily on the same road/route and the road therebetween is not necessarily straight, and neither AP1 nor AP2 are necessarily even on a road (i.e. depending on a, AP1 and/or AP2 are not on a road of the road system, let alone on route). But for simplicity of illustration in some explanations below, the focus of this second method is on, as a key metric, the proximity (and thereby, the Contextual Factor of communications link assessment) of AP2 and AP1. Put simply, for the purposes of this second method of approximating the likely AP experience of the PPR, the most important measure is |AP1→AP2|.

Assume NAP≧2 for a Predicted Proximal Region. The Predicted Spatial Overlap PSO for that PPR is related to the predicted proximity of AP1 and AP2* (i.e. |AP1→AP2*|), where AP2* is AP2 is “weighted”/“adjusted” to take into account the (possible) existence of other APs in that Predicted Proximal Region. Those other APs may be located closer to (or farther from) AP1 than AP2 is, measured directly (“as the crow flies”), or by (not) on the same road/route as AP1 and AP2 are.

As long as the “linear overlap” has a minimum positive value, i.e. PSOₘᵢₙ=(Predicted AP Range of AP1+Predicted AP Range of AP2)-|AP1→AP2|>0; then on a straight line segment drawn between AP1 and AP2, there should be a portion that is within the range of both AP1 and AP2. This is the threshold of “Wi-Fi experience”. A zero or negative value of PSOₘᵢₙ implicates the necessity of cellular coverage. How much greater than zero to PSOₘᵢₙ is a CWS Network system operator choice, dependent on application requirements and other factors.

The greater the proximity (i.e. the smaller |AP1-AP2|), the greater the linear coverage overlap is, and correspondingly, the greater the PTO to be enjoyed by vehicular mobile node as it travels between AP1 and AP2.

PTO=(2R−β×AP1−AP2|)÷vehicle speed

use |AP1→AP2| as the representative for the entire PPR (this make some sense if the PPR is a geographically fixed PPR of static shape that has been formed as the result of information/learning, e.g. a long stretch of straight road with many APs, or oval reflecting a high concentration of coffee shop Wi-Fi APs, etc.

PTO=(2R−βx|AP1-AP2*|)÷vehicle speed where AP2* is AP2 notionally “located” closer to AP1 as the result of the cumulative experience in the PPR of AP(i) for i=3, 4 . . . NAPs.

or

PTO=β×(Predicted AP proximities of |AP1-AP(i)|)÷vehicle speed

i=1, 2, 3, . . . NAPs (total number of APs in the Predicted Proximal Region)

where β is a factor whose arithmetic kernel is based on:

(1+[(NAPs−2)÷NAPs])⁻¹

NAPs=1, then β is undefined (the real world interpretation is that there is only one AP in the Predicted Proximal Region, so PSO/PTO is not a meaningful metric, and therefore do not use Wi-Fi).

NAPs=2, then β=1 (the real world interpretation is that there is only AP1 and then AP2 on a road, i.e. AP1-AP2

NAPs=3, then β=¾ (AP1 and AP2 on the route road, with AP3 on or off the road. Note that the inclusion of AP3 for this Predicted Proximal Region depends on the shape of Predicted Proximal Region, which may be dynamically decided, as explained elsewhere).

NAPs=4, then β=⅔ (AP1 and AP2 on route/road, with AP3 and AP4 on or off the road. Note that the inclusion of AP3 and AP4 for this Predicted Proximal Region depends on the shape and dimensions of Predicted Proximal Region, which may be dynamically decided, as explained below).

As NAPs increases, β approaches ½. In other words, the larger NAPs, the more the notional proximity of |AP1-AP2| increases towards % of the actual proximity therebetween.

Accordingly, in the above exemplary β, the “2” is to set the threshold beyond which the additional APs (beyond the first two APs) enhance the “AP experience” of the Predicted Proximal Region (and correspondingly, “punish” if NAPs is less than two APs). With only one AP in the Predicted Proximal Region, then β=0, and the PSO/PTO is zero, and so obviously avoid Wi-Fi or switch from Wi-Fi to cellular network. If NAPs in a Predicted Proximal Region=2, then β=1 (for example, see (simplest) case 1 below). As the NAPs in a Predicted Proximal Region increases beyond 2, then β decreases (from B=1 towards a theoretical maximum of β=½), and PTO correspondingly increases, reflecting the improving prospects of effective Wi-Fi. The above formula for β is monotonically decreasing and in some situations, the above formula for β will produce arithmetically benign results which are formulaically pathological, as reflecting a real world “dramatic” scenario, such as turning at an intersection).

Note that the preceding relationship/method is a calculation at a single point in time and is a particular case of the more general situation where PTO is related to the density of APs in a Predicted Proximal Region, and that Predicted Proximal Region is geographically dynamic (i.e. it moves as the vehicle travels) and its shape can be static or alter dynamically, as explained elsewhere. In the dynamic situation, the preceding relationship/method is calculated as the PPR moves and/or the shape alters (and in either case, the PPR includes/loses more APs so the NAPs changes).

More involved calculations can be performed (e.g. taking into account the inter-AP Proximities, differentially weighing APs in respect of their distance from the vehicle). But the simplest is to average the distance between the first AP (AP1) on the route and each “subsequent” AP in the Predicted Proximal Region (the first of the subsequent one being AP2).

The aforementioned formulaic expressions of β is only for illustrative, arithmetic purposes. Other formulaic expressions of β are possible, and in many situations, with other contextual factors and other empirical information, β can be formulated and tuned to “weigh” the relevancy of the more distant APs (i.e. relative to the vehicular mobile node) to improve the accuracy of PTO. The goal is to capture, with minimal computing processing and communications, the effect of increasing/decreasing the NAPs in a Predicted Proximal Region.

Approximation Method 3

The basic primitive in this (third) approximation method is the (spatial) relationship between the sequence of pairs of proximate APs that attempts to traverse the PPR with each pair satisfying PSOₘᵢₙ.

The “predicted AP Proximities” for the (geographically fixed and geographically dynamic) PPR can be calculated in one of several ways (combinations thereof). Examples include:

1. the average of {|AP(i)→AP(i)_{closest neighbor}|} for i=1 to NAPs (no notion of end of route)

2. the largest of {AP(i)→AP(i)_{closest neighbor}|} or) for i=1 to NAPs (no notion of end of route)

3. Determine the “circuit” (from AP1 forward on the route) as the average of {|AP(i)→AP(i)ₙₑₓₜ|}) for i=1, AP(i)ₙₑₓₜ . . . until end of route is reached or conclude (and additionally report to Mobility Manager 200) that the route cannot be predicted to be traveled to the end with acceptable Wi-Fi connectivity (i.e. for each AP of the circuit, with at least PTOₘᵢₙ). The end of the route is considered unreachable when the condition |AP(i)→AP(i)ₙₑₓₜ|<(2×Average AP Range) first fails for failure to find that AP(i)ₙₑₓₜ in satisfaction of that condition. At this point, it may be considered to change the PPR (e.g. from one shape to another shape and recalculate the PSO therefor) or consider a change in the route and recalculate the PSOs therefor).

4. Determine the “circuit” (from AP1 forward on the route) as the smallest (or largest) of {|AP(i)→AP(i)ₙₑₓₜ|} for i=1, AP(i)ₙₑₓₜ . . . until end of route is reached or conclude (and additionally report to Mobility Manager 200) that the route likely cannot be traveled to the end with acceptable Wi-Fi connectivity (i.e. for each AP of the circuit, with at least PSOₘᵢₙ/PTOₘᵢₙ). The end of the route is considered unreachable when the condition |AP(i)→AP(i)ₙₑₓₜ|<(2×Average AP Range) first fails for failure to find that AP(i)ₙₑₓₜ in satisfaction of that condition.

The first preference is to see the “next closest” AP as the next closest on the route but failing that, the next candidate is the next closest, as the “crow flies”. If still can't find a suitable next AP to satisfy PSOₘᵢₙ then quit this PPR.

Note that examples nos. 1 and 2 calculate for all APs in the Predicted Proximal Region.

Note that that examples nos. 3 and 4 are recursive formulas that try to predictively “build” the “circuit” (from AP1 to other APs of sufficient communications quality (i.e. achieve at least PSOₘᵢₙ or PTOₘᵢₙ) to reach the end of the route, and that it may or may not reach that end route (in which case, it returns the conclusion to switch to cellular network).

There are common recursive algorithms for traversing nodes/leaves of a (graph) trees such as mazes, including optimizations with approaches like “depth first” or “breadth first”, backtracking, pruning, and the like. There is a close mapping between the problem of traversing a maze and the problem of trying to create a “circuit of APs” from a route through a PPR. For example, a “wall” in a maze is analogous to the proximities between current AP and next AP being insufficient for effective Wi-Fi handoffs. For example, just as a given maze may be untraversable, a given PPR may have (for a vehicular mobile node with particular, real time and static Contextual Factors) have insufficient AP density (or an unfortunate geometric distribution of APs for effective handoffs in Wi-Fi) to justify Wi-Fi in the PPR (i.e. the decision should be to switch to cellular network). As explained elsewhere (in relation to Network Health management), faulty APs (or related upper layer infrastructure) may be put on a “blacklist” and be the subject of warnings and advisories. An insufficient PSO between two APs (whether measured directly or traveled “on the road” or “on the route”, as the case may be) may be also advised upstream to Mobility Manager 200 for special handling or merely as information for it to develop a complete picture of the networks (even if those two APs are otherwise functioning adequately).

Regardless of the reason, a “circuit” to AP11 (the end of the route), is sought. So the first part of the circuit is noted as AP1→AP7, then AP7→AP6→AP8→AP3. The AP3-AP10 does not satisfy PTOₘᵢₙ

And so AP3-AP5 is determined to be sufficient, and then the circuit ends with AP5→AP11.

If the “circuit” can be completed from AP1 to the end of the route (with a sequence of APs, each separation inbetween satisfying PSOₘᵢₙ

then return the . . . else abort Wi-Fi.

Thus the same map (depending on how viewed and formulated) results in different “Predicted AP Proximities”.

Instead of a “uniform geometric distribution” model for a Predicted Proximal Region (whether square, rectangle, triangle, ellipse; the fixed square grid model of FIG. 9), the focus in the geographically dynamic Predicted Proximal Region model is on |AP1-AP2| especially, and then on subsequent AP Proximities. As with the square grid model, the threshold of |AP1-AP2| must be satisfied initially. But after that, the presence of AP3, AP4, and so on, is arithmetically included (without regard to any notional location of AP3, AP4). The PPR moves geographically, so that as time passes and vehicular mobile node moves, AP1 is “replaced” and AP2 ends up as AP1, etc.

Alternatively, the closest (i.e. neighboring) AP is measured by the lesser of (physical separation (“as the crow flies”) and the distance traveled on a route between them.

For simplicity of Illustration, assume Average AP Range of an AP in a Predicted Proximal Area, is a radial 500 feet.

Case 1 (simplest). With reference to FIG. 11, the route is a straight main road (not shown) between AP1 and AP2 (a driver passes one roadside coffee shop Wi-Fi AP and then another down the road). This is shown by the arrowed line segment between AP1 and AP2. Thus the Predicted Proximal Region is modeled by the line/road that includes {AP1 and AP2}. The distance between AP1 and AP2, |AP1-AP2|, is determined by vehicular mobile node or Mobility Manager 200 as about 500 feet. If vehicle is travelling at about 35 mph or greater down the road, then the spatial (linear, in this case) overlap between AP1 and AP2 is about 500 feet. With β=1, the PSO “spatial overlap”, Predicted AP Proximities, PSO and PTO can be calculated.

Case 2. The route is on a straight main road with AP1 and then AP2, as in case 1 but there is also AP6 proximate to AP2 but perhaps on a secondary road parallel to the route. Predicted Proximal Region is established as a triangle (as shown as Triangle 1 in FIG. 11). Thus Predicted Proximal Region covers {AP1, AP2 and AP6}. The average of |AP1-AP2| and |AP1-AP6| is calculated, and with a suitable β, PSO and PTO can be calculated.

Case 3. (the 2-D, rectangular version of the linear case 1). The route is on a straight main road with AP1 and then AP2, and also two stores—AP6 and AP7 on secondary road(s) (not shown) parallel to the main road. Predicted Proximal Region is established as a rectangle (as shown) that covers {AP1, AP2, AP7}. If the rectangular Predicted Proximal Region were redefined with larger dimensions, then (not shown), AP6 would be covered. The average of |AP1-AP2|, |AP1-AP6| and |AP1-AP7| is calculated, from which PSO can be calculated, and with a suitable γ, PSO and PTO can be calculated.

The “canonical” measure is the simplest and most immediate experienced by vehicular mobile node, i.e. the separation between AP1 and AP2 on a straight path. Other measures are possible (that include considering (a) distances between |AP2-AP(i)|, i>2 (i.e. wrt the second AP, and not wrt AP1)); (b) distances between |AP(i)-AP(j)| where i,j are >2)

Mobility Manager 200 (and/or vehicular mobile node) calculates (based on vehicular mobile node velocity, vehicular mobile node mobility history, mobile node history (i.e. a cell phone that is being carried by the driver and not necessarily vehicular mobile node) the Network Health assessment of the area that vehicular mobile node will likely visit, the best geometric shape of Predicted Proximal Region (for including APs to calculate the most realistic PTO).

Mobility Manager 200 has a map of the road system and has information on all the APs that are part of the heterogeneous networks that it manages (or at least that it has visibility on their performance). Part of the AP information includes its geographical location (esp. in respect of the road system) and its “communications health”. Mobility Manager 200 knows the “communications health” (from lower layer) link quality to Layer 3 throughput). Where an AP is determined to be within a Predicted Proximal Region (geographically fixed/dynamic) of a prescribed shape, its “health” is then considered whether to include it (or not) in that PPR. The “health” situation may be so serious as to disqualify that AP from being included in a Predicted Proximal Region (for the PTO calculation, or for other purposes) (until that unhealthy status has been updated positively). For example, the “network health” reports that Mobility Manager 200 has received from another mobile node(s) (vehicular or otherwise), as processed by Network Health Assessment 210) indicate that no Layer 3 traffic has been detected from a particular AP, or that for certain application requirements, that AP is providing only intermittently acceptable link quality, and so that AP is not part of the Predicted Proximal Region (and correspondingly, all pertinent calculations are re-done).

The calculations (and related actions and selections and choices of shapes, and other activities, approximations, services, storage, knowledge and the like), that are described as being performed, maintained or owned by Mobility Manager 200 or by vehicular mobile node (or being described without specifying the performing entity) can be distributed to Mobility Manager 200 or vehicular mobile node or some intermediate or external system 500 (e.g. that services a particular region of a large city). The physical location of the calculations is an implementation and design choice that depends on the resources and constraints (computational, hardware, software) of entities that are downstream of Mobility Manager 200 (including vehicular mobile node). If vehicular mobile node has a sufficient knowledge and calculation powers (e.g. map with locations of APs), then many calculations such as establishment of a route, the selection of Predicted Proximal Region(s) for the route, the inclusion (and exclusion) of APs in a Predicted Proximal Region) can be calculated quickly by vehicular mobile node in real time as it travels the route. There are many way, including using the entire length of the road that traverses the “super-squares” divided by the total number of NAPs therein (for immediate purpose of illustration, let 10+14+2+14 be the NAPs in the four squares) (or almost equivalently, those numbers could be the respective AP Densities; or the PSO may be the average thereof or smallest or largest thereof (with each square being amenable to above-described geometric distribution uniformity of APs).

Orientation of the PPR Shape

The orientation can be established by prediction, especially with a route established. E.g. PPR ellipse [B-C], as shown in FIG. 10, is oriented with its major axis running North West to South East, i.e. the far end of ellipse, location [C], and yet farther, location [E] is predicted to be on the overall geographical trajectory of the vehicular mobile node, so that orientation is appropriate even though there are turns and bends in the route intermediate [B] and [C] that suggest otherwise.

This leads to another method of orientation, and can be used as a default orientation (in the absence of an established route, or in the case of a traveled deviation from an established route). The orientation of the PPR shape at any given time, aligns with the direction of the road and the velocity of the vehicle on that road, i.e. the instantaneous direction of the vehicle, sampled periodically.

The Position of the Vehicle Internal within the Shape.

When travelling, the region of interest to a vehicular mobile node will be “in front” of the vehicle along its route. Most of the “space” of a PPR is “in front” of a travelling vehicle. But there are “boundary” conditions or “transition areas” where “upcoming” may not necessarily be “in front”. For example, when the vehicle is relatively motionless, slowing down or the gear selected is “reverse”), the region of upcoming interest may behind or laterally of the vehicle's current position. As the vehicle slows down, what was the ellipse or triangle or rectangle, “looking forward” from the vehicle at one end, may be morphed into the circle, where the vehicle/mobile node is in the middle.

One exemplary boundary condition occurs when the vehicle has stopped (e.g. at traffic light or at a bus depot) and so its next direction (without other information) is unknown and perhaps unknowable in some situations). So the position of vehicular mobile node within a geographically dynamic Predicted Proximal Region of an alterable shape, that normally is at one “end”, shifts toward the center of PPR shape of circle 631 (as seen in FIG. 11).

No Route or Deviation from Route

If no route is established (by the driver or MM 200) or if the vehicle (upon starting on a route) deviates from the route, then the path of vehicular mobile node (still travelling on a road) is predicted on a real time basis based on factors and methods that do not depend on the information that a route provides. In that case, the selection of PPR goes into default mode, with example described next.

In default mode, the PPR may be geographically dynamic (i.e. the PPR is “moving geofence”); or the vehicular mobile node will use the information (e.g. NAPs, PSO) associated with the geographically fixed grid squares of FIG. 9. The shape may be alterable or static, with suitable default dimensions. The explanations and techniques described above, mutatis mutandi are applicable to this situation. In particular, references to, and requirements relatable to, a “route” are either inapplicable or may be relaxed (e.g. in respect of “next” and “closest” for proximity) or the metric of proximity is based purely on “as the crow flies”. But the descriptions of a geographically dynamic PPR remain applicable. An exemplary default PPR is a geographically dynamic PPR shape of static triangle 600, with orientation of the triangle aligned with the direction of the vehicle (as explained above) and the location of the vehicular mobile node with the triangle is at the apex of the triangle with a widening “window” looking forward to the upcoming AP experience as the node travels.

Calculating and Choosing Shapes.

The above examples of classical shapes (such as line segment, square, triangle, rectangle, ellipse) are non-limiting. Other shapes suggest themselves with more knowledge of the road system, real world artifacts of the region and the like. For example, there may be no exits from a road/route between two points or that the route partially traverses a forest with moving foliage, in which case, a PPR that “hugs” the road would be appropriate compared to a triangular PPR. The ribbon-like rectangle shape [C-D] of FIG. 10, can be considered as the 2-D version of the geographically fixed PPR static shape of the line segment/route [C-D] or even [A-B] (and can be implemented by adjusting a to be large enough so that APs not precisely “on the route/road” will be included in the PPR of such a rectangle).

Or there may be a largish natural obstruction (such as a large bamboo groove) in a particular location so that a user-defined shape cognizant of such obstruction, is appropriate. The choices of shapes may be based on environmental artifacts learned. For example the portion of route [D-E] is triangular (in FIG. 10) to recognize a narrowing valley outside of which are substantial communications obstructions. Continuing with FIG. 10, a ribbon-like rectangle (such as PPR [C-D]) that hugs or tracks responsively the road, may be more accurate than the squares and “super-squares” concatenation of FIG. 9 that are traversed; but that may be more accurate on a short term basis because if the objectives are more long range, then PPR shape of large ellipse [B-C] of FIG. 10 might be better.

circles, triangles, rectangles, ellipses and other geometric shapes (classical, user-defined or combinations thereof, whether automatically adjusted responsively to artifacts of the PPR or as driver/Mobility Manager 200 instructs).

From the basic modeling primitive (e.g. of the “linear PPR”) to more generalized, context-sophisticated modeling, the choices and the hybrid gradations may be decided by CWS Network system operator (based on processing and memory resources, battery constraints, latency of communications between Mobility Manager and vehicular mobile nodes, etc.). Combinations and hybrid organizations of PPRs may be advantageously created (depending on objectives and constraints). For example, on a route, in some areas, a geographically fixed PPR square but in other places, a geographically dynamic PPR. And as explained above, a shape can be alterable or static, and can themselves be composed of smaller mini-shapes. The calculation and composition of shapes is influenced by objectives such as granularity sought and by constraints (in resources in time, computational, and the like).

Learning

The approximation methods for Predicted AP Proximities (especially nos. 3 and 4) also collect information that is useful for Mobility Manager 200 and its database of information (e.g. to refine the geographically fixed PPR shapes per routes; adjust β weighing formula), as well as benefiting more immediately the vehicular mobile node (e.g. adjusting scanning parameters).

When implemented in the real world, β will include other influences to result in a realistic figure as a weighting factor to AP2. That said, β provides an exemplary kernel of arithmetic recognition that |AP1⇄AP2| should recognize environmental factors that are part of travel “on the road”. To return to the example of surging vehicular and/or population densities around a large sporting venue, although the Euclidean distance between AP1 and AP2 appears short to a flying crow, other realities in fact make AP2 further away, and so AP2* must recognized (either by β or some other method). Real time surges in human and vehicular densities will also affect AP2* (too much traffic likely creates much less Predicated AP Proximities).

If on Cellular

Some of the preceding explanations have the premise that vehicular mobile node is currently associated with an AP (denoted AP1 in many situations described above). If vehicular mobile node is operating on a cellular network, then the preceding methodologies and insights can be employed to determine if/when to switch to Wi-Fi. The only change would be that AP1 is not the AP that is currently associated with but is the first legitimate candidate AP (e.g. could be the AP that is nearest to vehicular mobile node at a given time and could be associated with).

Background Scanning Interval (BSI)

PTO=Predicted Spatial Overlap (PSO)/Velocity, which is approximated by Predicted AP Proximities+speed (of vehicular mobile node)

The “minimum PTO” threshold is:

PTOₘᵢₙ=2(ST+BSI)=PSOₘᵢₙ/V or BSI=PSO_{min/}2V−ST

Thus:

BSIₘₐₓ=(PTOₘᵢₙ/2)−ST

More informatively, 0≦BSI≦(PTO/2)-ST determines the practical range of BSI.

There is no practical upper limit on BSI (strictly speaking, there is no need to scan if vehicular mobile node is stationary (i.e. V=0) and associated with an AP) but the above relationship acceptably drives the lower bound to infinity in that case.

A method for setting and adjusting BSI is described, next, in pseudo-code.

```
Initialize location, heading and speed (i.e get a GPS fix)
Set BSI=−1 (disable)
Continually do the following: # with pauses to avoid burning cycles.. {
Determine (Contextual Factor of) application requirements and set appropriate
BSIₘᵢₙ. (explained below)
Set ST for the proximate communications environment (explained below)
If speed== 0 {
    Set BSI =−1 (disable)
  } else {
    Calculate PTO
    Calculate BSIₘₐₓ = PTO/2 − ST
    If (BSI == −1) or (BSIₘₐₓ < BSI) {
      Set BSI = BSIₘₐₓ
    }
  }
  If (BSI ==−1) {
    Select WiFi
  } else if (BSI >= BSIₘᵢₙ) {
    Select WiFi
    If BSI << BSIₘₐₓ {
      BSI = BSI + (BSIₘₐₓ − BSI)/2 # this is to allow BSI to ramp up and improve
application performance
    }
  } else {
    Select Cellular network
    Set BSI = BSIₘᵢₙ
  }
}
```

Where the new BSIₘₐₓ is lower than the current BSI (or current BSI is −1), then (optionally) BSI can be lowered based on acceleration of vehicular mobile node or PSO of the PPR. For example,

```
...
  If (BSI == −1) or (BSIₘₐₓ < BSI) {
    If acceleration > 1m/s/s {
      Set BSI = (BSIₘₐₓ + BSIₘᵢₙ)/2
    }
  }
...
Or
...
  If (BSI == −1) or (BSIₘₐₓ < BSI) {
    If PSO > 500 ft {
      Set BSI = BSIₘₐₓ
    } else if PSO > 200 ft {
      Set BSI = 0.9 * BSIₘₐₓ
    } else {
      Set BSI = (BSIₘᵢₙ + BSIₘₐₓ)/2
    }
  }
...
```

Optimizing Scanning

As mentioned above, ScanTime (ST) needs to be set (based on the channels to scan). Implicit in the process is to minimize ScanTime without unacceptable degradation of other performance metrics. Minimization can be accomplished in several ways including adjusting mindwell/maxdwell and maxOffChannelTime (in the Wi-Fi context); and reducing the number of channels that are instructed to be scanned. The number of channels can be reduced by several methods. One method is if Mobility Manager 200 knows which channels are in use by proximate APs in or near a PPR (perhaps by learning from the operator of the Wi-Fi network), and if so, vehicular mobile node is instructed to skip those used channels to scan. Another method to reduce ST is to scan only when vehicular mobile node speed slows down sufficiently—whether motivated by environmental factors such as traffic congestion, or by deliberate driver decision (perhaps in response to a message from vehicular mobile node to driver) to slow speed if Wi-Fi coverage is desired.

As explained elsewhere, Mobility Manager 200 (and its Network Health Assessment 210) know the “network health” of all the heterogeneous networks under its supervision, and the “health” of each node (mobile or not) in such networks. In particular, they know the “connectivity health” of every AP (not just at a low level like link assessment but also at higher layers like Layer 3 throughput). When Network Health Assessment 210 receives a report (from a mobile node) that a certain AP is faulty, Mobility Manager 200 notifies all vehicular mobile nodes with an appropriate change in policies and disqualifies that faulty AP from inclusion in any PPR of any (vehicular) mobile node and correspondingly of any calculations of PTO, NAPs, PSO, and related), with suitable warnings sent to all (vehicular) mobile nodes and any intermediate or external systems 500 so they do not miscalculate PTO, PSO and related metrics.

BSImin

As mentioned above, the application requirements guide (if not dictate) the setting of BSIₘᵢₙ. Low bandwidth and/or latency-tolerant applications can handle BSI down to zero (for example, for email applications, BSI is in the order of seconds, and BSIₘᵢₙ can be set appropriately (very) low. Conversely, high-bandwidth/latency-sensitive applications require large BSI, the larger the better (for example, voice/video applications, where delays are noticeable) and BSIₘᵢₙ should be set appropriately high. In between, intermediately-sensitive applications (such as operating on File Transfer Protocol) can handle a BSI in the order of minutes (e.g. 1-5 minutes) and BSIₘᵢₙ is set appropriately.

Multi-Radios.

In the preceding about BSI, implicit was the use of one radio in or for vehicular mobile node. With two or more radios, an effective division of labour can be accomplished.

For example in the case of two radios, the first is dedicated to the active passing of traffic while passively scanning (collecting beacons on the channel it is operating on). The second radio continually scans all other channels. This is approximately equal (in terms of speed of finding new candidate APs) to background scanning with BSI=0, but is better because ST is reduced (since there is no pause to scanning to exchange buffered traffic). When a “better” AP is found, the first radio is interrupted and switched to that AP.

For example in the case of three or more radios, the granularity of the division of labour can be improved—the set of candidate channels can be sub-divided and shared by the second and third ratios, resulting in lower ST through parallelism

With many radios, and knowledge of “likely” channels to find new candidate APs, one can dedicate radios to passively scan (e.g. listen for beacons every 100 ms) those channels and leave the remaining radios to actively scan the less-likely channels

N+1 radios, where N=the number of candidate channels (other than the channel that is passing traffic): one radio passes traffic, and the N radios are assigned to unique channels to passively scan.

Network Health Management

The basic premises include:
Network density is increasing to maximize spectrum re-use
   Wi-Fi networks require several orders of magnitude more APs than typical cell systems have towers
Increasing density means increasing number of points of failure, which makes it increasingly difficult for an operator to maintain quality of service
Many problems are not immediately detectable from the infrastructure side so input from the mobile node is imperative
Mobile Nodes will Increasingly be equipped with multiple radios which provides an opportunity to navigate around failures, but due to network density issues such navigation must be automated to provide continuity of service

Accordingly:
Network Health Assessment or Authority (NHA) 210 is configured to be capable of:
   receiving network failure reports from mobile nodes (MNs) (vehicular or otherwise), infrastructure monitoring systems and users.
   correlating a plurality of MN network failure reports to identify persistent, or transient but recurring, network faults
   instantiating a trouble ticket with pertinent details of the perceived network fault to enable further troubleshooting and repair of the problem
   delivering a network impact advisory to Mobility Manager (MM) 200 to inform it of the scope of impact of the perceived network problem (such as geography, frequency, Point of Attachment (PoA) at layer 2)
   receiving notice of clearance of trouble tickets and informing the MM of the termination of network impact.
   delivering a network test request to an MM 200
   receiving network test reports from MNs
   Correlating network test reports to substantiate a network failure report or the clearance of a trouble ticket
Mobility Manager (MM) 200 configured to be capable of:
   receiving network impact advisories and report cancellations from NHA 210 and disseminating said reports/cancellations to a subset of managed MNs perceived by the MM 200 to be affected by the network fault.
   receiving a network test request from an NHA 210 and selecting suitable candidate MNs to perform the requested test(s) and dispatching said requests to the candidate MNs.
a plurality of mobile nodes (MNs) (vehicular or otherwise) capable of:
   detecting network failures
   reporting details of said network failures to NHA 210
   receiving network impact advisories/cancellations from MM 200 and using the provided information to assist in the interpretation of policy for selecting network links.
   receiving network test requests from an MM 200
   Executing the requested network tests and reporting the results of those tests to NHA 210.

NHA 210 may be an integrated component of MM 200 (as shown in FIG. 8) or a discrete component (e.g. external systems 500).

Network failure reports may be forwarded directly from MN to NHA 210 or be relayed by intermediate devices. Said reports may be forwarded in real time via alternate communication links at the MN's disposal or be stored by the MN and forwarded at a future time based on network connection availability, scheduled report intervals, etc.

Examples of network faults reported by MNs:
PoA not detectable by the MN when within the expected operating range (perhaps Predicted AP Range) of said PoA
PoA detected but rejecting connection with valid security credentials
PoA accepts connection but does not pass traffic (to suggest a higher layer obstruction)
PoA accepts connection but provides degraded service

Examples of Network Faults Reported by Infrastructure Monitoring Systems
Exhaustion of backhaul capacity
Exhaustion of spectral capacity
Client connection attempt with invalid security credentials
Abandoned connection attempt (i.e. no errors but client simply did not proceed)
Abandoned client session (client stopped communicating without formally indicating termination/transfer of the network session)
Prohibited network behavior attempted by client

Examples of Network Faults Reported by Users
service interruption due to planned maintenance
service interruption due to externally reported event (power blackout, fire, etc that for some reason is not automatically reported by infrastructure monitoring systems)
forecast service degradation/failure due to anticipated events:
   hurricanes
   conventions or other events likely to cause a mass congregation of users

### Operational Example 1

1. An MN is provisioned to use Wi-Fi network “network A” on channels 1, 6 or 11 in a given region. The MN enters the specified region (as determined by an embedded GPS receiver) and begins to scan the prescribed channel set. A plurality of Access Points are detected and the MN selects the one with the strongest signal and associates. The connection is accepted and the MN begins utilizing the AP to pass traffic.

2. The MN continues to move through the region and eventually arrives at a location where signal strength of the AP it is currently associated has diminished and a new AP with better signal strength has been detected. The MN successfully associates with the new AP but is unable to pass traffic. User sessions are disrupted.

3. The MN continues to move and eventually locates a new AP with better signal characteristics and successfully associate ts with it and is able to pass traffic. User sessions are resumed. The MN formats a network failure report identifying:
the ESSID of the network (“network A”)
the BSSID of the AP the MN associated with in step 2
the channel the AP is operating on.
the length of time and range of geographic locations the MN traversed while associated with the offending AP
the nature of the failure (signal OK, association OK, data transmission failure)

4. MN dispatches the network failure report to NHA 210.

5. NHA's correlation engine finds no corroborating reports and places this network report in a “pending state” and takes no further action.

6. Over time a plurality of MNs encounter the same difficulty as the first and forward network failure reports to NHA 210. NHA 210 correlates the new reports with the initial one and concludes there is a persistent problem with the referenced AP.

7. NHA 210 instantiates a trouble ticket to dispatch a technician to diagnose and repair the offending AP. Further, NHA 210 transmits a network impact advisory to the MM instructing that the offending AP is not functioning properly.

8. The MM identifies all MNs within 2000 ft of the offending AP and transmits the network impact advisory to them. Every 60 s, the MM 200 checks for MNs that have moved within 2000 ft of the AP and transmits the network impact advisory to them.
in another embodiment, instead of explicitly notifying MNs, MM 200 maintains a database of active network impact advisories indexed by location, network technology, channel, etc. In such an embodiment, MNs periodically poll for updated lists of network impact advisories applicable to them based on whatever criteria is deemed suitable.

9. MNs in receipt of the network impact advisory add the offending AP to a blacklist such that the MN will not attempt to associate to that AP. If the network is designed with sufficient density such that there are alternative APs detectable from any given location, MNs seamlessly migrate to an alternate AP when in the vicinity of the offending AP.

10. A technician diagnoses and repairs the problem with the AP and closes the trouble ticket.

11. NHA 210 receives notification that the trouble ticket has been closed and informs the MM 200 that the network impact advisory is cancelled.

12. MM 200 notifies all MNs that had previously received the network impact advisory that it has been cancelled.
in the alternate embodiment described in step 8, MM 200 merely deletes the network impact advisory from the database such that MNs no longer find it on their next poll.

13. MNs, upon receipt of the cancellation of the network impact advisory, remove the repaired AP from their blacklists and resume connecting to it when appropriate.

### Operational Example 2

1-4. Same as example 1

5. NHA's correlation engine finds no corroborating reports so it delivers a network test request to MM 200 requesting UDP and TCP throughput and latency tests through the specified AP.

6. MM 200 selects suitable candidate MNs in the vicinity of the specified AP and transmits the network test request to them.

7. Upon receipt of the network test request, the MNs that have no alternate network links for user traffic wait for their Wi-Fi radio to go idle. MNs with alternate links reroute user traffic via those links. In both cases once the Wi-Fi radio has been freed up, the MN scans for the specified AP, associates with it, executes the prescribed network test and forwards a network test report to NHA 210.

8. Upon receipt of network test reports confirming the AP is not properly functioning, MM 200 instantiates a trouble ticket and proceeds with steps 7-12 from the previous example. Conversely, if the test results indicate the AP is performing correctly, the initial failure report is held in pending state for a period of time to determine if it is a transient recurring problem.

Although the method, system and devices of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims.

1. (canceled)

2. A method for managing wireless connectivity of a vehicular mobile node travelling along a route, the method comprising:
determining a predicted route, the predicted route defined by a start location and an end location;
defining a set of predicted proximal regions, wherein each predicted proximal region has a shape which encompasses at least a portion of the predicted route and wherein each predicted proximal region has associated therewith metrics defining access point availability therein; and
managing the wireless connectivity of the vehicular mobile node travelling within a current predicted proximal region based on the metrics associated with the current predicted proximal region, said current predicted proximal region included in the set of predicted proximal regions.

3. The method according to claim 2, wherein the shape of at least one predicted proximal region of the set of predicted proximal regions is defined by one or more geographically fixed shapes.

4. The method according to claim 2, wherein the shape of at least one predicted proximal region of the set of predicted proximal regions is defined dynamically, wherein parameters reflective of movement of the vehicular mobile node are used to determine the shape of at least one predicted proximal region.

5. The method according to claim 4, wherein the shape of the at least one predicted proximal region is dependent on a speed of movement of the vehicular mobile node.

6. The method according to claim 2, wherein at least one predicted proximal region of the set of predicted proximal regions dynamically changes in one or more of shape, dimension and location based on movements of the vehicular mobile node.

7. The method according to claim 2, wherein the metrics associated with a particular predicted proximal region are indicative of a number of access points within the particular predicted proximal region.

8. The method according to claim 2, wherein the metrics associated with a particular predicted proximal region are indicative of a predicted spatial overlap which is indicative of an average separation between access points within the particular predicted proximal region.

9. The method according to claim 2, wherein the metrics associated with a particular predicted proximal region are indicative of a predicted temporal overlap which is indicative of a density of access points within the particular predicted proximal region.

10. The method according to claim 9, wherein the predicted temporal overlap is indicative of a time frame during which the vehicular mobile node can be connected to a first access point while searching for a subsequent access point.

11. A device for managing wireless connectivity of a vehicular mobile node travelling along a route, the device comprising:
a processor; and
machine readable memory storing machine executable instructions which when executed by the processor configure the device to:
determine a predicted route, the predicted route defined by a start location and an end location;
define a set of predicted proximal regions, wherein each predicted proximal region has a shape which encompasses at least a portion of the route and wherein each predicted proximal region has associated therewith metrics defining access point availability therein; and
manage the wireless connectivity of the vehicular mobile node travelling within a current predicted proximal region based on the metrics associated with the current predicted proximal region, said current predicted proximal region included in the set of predicted proximal regions.

12. A computer program product comprising a non-transitory computer readable medium storing computer executable statements and instructions thereon that, when executed by a computer, perform operations for managing wireless connectivity of a vehicular mobile node travelling along a route, the operations comprising:
determining a predicted route, the predicted route defined by a start location and an end location;
defining a set of predicted proximal regions, wherein each predicted proximal region has a shape which encompasses at least a portion of the route and wherein each predicted proximal region has associated therewith metrics defining access point availability therein; and
managing the wireless connectivity of the vehicular mobile node travelling within a current predicted proximal region based on the metrics associated with the current predicted proximal region, said current predicted proximal region included in the set of predicted proximal regions.
